(19) United States
(12) Patent Application Publication
(10) Pub. No.: US 2025/0272819 A1
(43) Pub. Date: Aug. 28, 2025

(54) PROCESSING METHOD, PROCESSING SYSTEM, AND STORAGE MEDIUM

(71) Applicant: MAKEBLOCK CO., LTD., Shenzhen (CN)

(72) Inventors: Yanchen GUO, Shenzhen (CN); Shiling WU, Shenzhen (CN); Yu WANG, Shenzhen (CN); Haihan ZENG, Shenzhen (CN)

(73) Assignee: MAKEBLOCK CO., LTD., Shenzhen (CN)

(21) Appl. No.: 19/066,112

(22) Filed: Feb. 27, 2025

(30) Foreign Application Priority Data
Feb. 28, 2024 (CN) 202410221268.1
Aug. 20, 2024 (CN) 202411146500.6
Jan. 17, 2025 (CN) 202510077627.5

(51) Int. Cl. G06T 7/00; G06F 3/0481; G06F 3/0484; G06T 7/73; G06V 10/70; G06V 10/94

(52) U.S. Cl. CPC G06T 7/0004; G06F 3/0481; G06F 3/0484; G06T 7/73; G06V 10/70; G06V 10/945; G06T 2200/24; G06T 2207/30164; G06V 2201/06

(57) ABSTRACT

A processing method, a processing system, and storage medium thereof are provided. The processing method includes obtaining processing factor information. The processing method also includes obtaining and displaying a processing preview diagram based on the processing factor information. The processing preview diagram includes one or more preview patterns corresponding to one or more candidate parameter-value sets, respectively. The processing method further includes, in response to a selection operation performed on the processing preview diagram, determining a candidate parameter-value set corresponding to the selection operation to be a target parameter-value set. The processing method further includes controlling a processing device to process a target workpiece based on the target parameter-value set.

### CROSS-REFERENCE TO RELATED APPLICATIONS

This application claims priority to Chinese Patent Application No. 202510077627.5, filed on Jan. 17, 2025, which claims priority to Chinese Patent Application No. 202410221268.1, filed on Feb. 28, 2024. This application also claims priority to Chinese Patent Application No. 202411146500.6, filed on Aug. 20, 2024. The entire contents of each of the above-referenced applications are expressly incorporated herein by reference.

### BACKGROUND

The present disclosure relates to the field of material processing technologies, and specifically relates to a processing method, a processing device, a processing system, and storage medium thereof.

Fine processing technologies (such as line drawing, engraving, or cutting) play an important role in the modern manufacturing and processing industry. At present, when applying a processing device to process a workpiece, it is difficult for a user to find out suitable values of the processing parameters for the processing process. Thus, the processing efficiency is relatively low.

### SUMMARY

In one aspect, a processing method is disclosed. The processing method includes obtaining processing factor information. The processing method also includes obtaining and displaying a processing preview diagram based on the processing factor information. The processing preview diagram includes one or more preview patterns corresponding to one or more candidate parameter-value sets, respectively. The processing method further includes, in response to a selection operation performed on the processing preview diagram, determining a candidate parameter-value set corresponding to the selection operation to be a target parameter-value set. The processing method further includes controlling a processing device to process a target workpiece based on the target parameter-value set.

In some implementations, obtaining and displaying the processing preview diagram based on the processing factor information includes: obtaining a processing parameter matrix based on the processing factor information, where the processing parameter matrix includes one or more matrix elements that are formed by the one or more preview patterns and indicate the one or more candidate parameter-value sets, respectively; and displaying the processing parameter matrix in an interaction interface.

In some implementations, in response to the selection operation performed on the processing preview diagram, determining the candidate parameter-value set corresponding to the selection operation to be the target parameter-value set includes: receiving, from the selection operation, an input to select a first matrix element of the processing parameter matrix through the interaction interface; and in response to the input to select the first matrix element, determining the candidate parameter-value set corresponding to the first matrix element to be the target parameter-value set.

In some implementations, the one or more candidate parameter-value sets include one or more first values of a first processing parameter and one or more second values of a second processing parameter, respectively. The processing method further includes generating the processing parameter matrix at least by: determining a first sorting position of each matrix element in a first direction based on a corresponding first value of the first processing parameter associated with the corresponding matrix element; determining a second sorting position of each matrix element in a second direction based on a corresponding second value of the second processing parameter associated with the corresponding matrix element; and arranging each matrix element in the processing parameter matrix based on the first sorting position and the second sorting position of the corresponding matrix element.

In some implementations, in the processing parameter matrix, a matrix element having a larger first value of the first processing parameter has a larger first sorting position in the first direction, and a matrix element having a larger second value of the second processing parameter has a larger second sorting position in the second direction.

In some implementations, each matrix element includes a corresponding preview pattern that reflects a processing effect produced by a candidate parameter-value set indicated by the matrix element; and the processing parameter matrix further includes the processing factor information, and the processing factor information includes at least one of a material property, a device type of the processing device, or a processing type of the processing device.

In some implementations, the processing parameter matrix is in an image format. The processing method further includes: in response to a hovering operation performed on the processing parameter matrix, obtaining a relative position of the hovering operation with respect to the processing parameter matrix; based on the relative position of the hovering operation, determining that the hovering operation points to a second matrix element in the processing parameter matrix, and determining a position of the second matrix element; and displaying a hovering identification image at the position of the second matrix element. The hovering identification image includes at least one of an identification effect diagram matching a pattern size of the second matrix element or a corresponding candidate parameter-value set indicated by the second matrix element.

In some implementations, displaying the processing parameter matrix in the interaction interface includes: displaying a processing parameter configuration panel in the interaction interface, where the processing parameter configuration panel includes the processing parameter matrix; and in response to a click operation on the processing parameter matrix, enlarging the processing parameter matrix and displaying the enlarged processing parameter matrix in the interaction interface.

In some implementations, the interaction interface further displays a configuration panel that includes a parameter adjustment control. The processing method further includes: in response to an adjustment operation to adjust a value of a processing parameter in the target parameter-value set through the parameter adjustment control, updating the target parameter-value set based on the adjusted value of the processing parameter; and generating an updated processing preview diagram based on the updated target parameter-value set and the processing factor information; and displaying the updated processing preview diagram in the interaction interface.

In some implementations, the processing method further includes selecting at least one processing parameter and at least one candidate value range of the at least one processing parameter; given one or more processing factors, performing a processing test based on the at least one processing parameter and the at least one candidate value range to obtain a test result corresponding to the one or more processing factors, where the one or more processing factors includes at least a material property of the target workpiece to be processed; adjusting the at least one candidate value range based on the test result to obtain at least one target value range of the at least one processing parameter corresponding to the one or more processing factors; and by using the at least one processing parameter as at least one dimension of the processing parameter matrix, selecting one or more values from the at least one target value range to generate one or more matrix elements of the processing parameter matrix, respectively. The one or more candidate parameter- value sets corresponding to the one or more matrix elements include the one or more values of the at least one processing parameter, respectively.

In some implementations, by using the at least one processing parameter as the at least one dimension of the processing parameter matrix, selecting the one or more values from the at least one target value range to generate the one or more matrix elements of the processing parameter matrix includes: generating the one or more preview patterns based on the one or more candidate parameter-value sets; and using the one or more preview patterns and the one or more candidate parameter-value sets to form the one or more matrix elements. The processing method further includes storing the processing parameter matrix and a mapping relationship between the one or more processing factors and the processing parameter matrix.

In some implementations, the processing factor information describes at least one of a material property, a device type, or a processing type. Obtaining the processing parameter matrix based on the processing factor information includes: obtaining a mapping table that describes a mapping relationship between processing factors and processing parameter matrices; and querying the mapping table to obtain the processing parameter matrix that matches the at least one of the material property, the device type, or the processing type.

In some implementations, obtaining and displaying the processing preview diagram based on the processing factor information includes: displaying an interaction interface that includes a configuration panel, where the configuration panel includes a parameter adjustment control for adjusting a value of at least one processing parameter; in response to an adjustment operation to adjust the value of the at least one processing parameter through the parameter adjustment control, displaying the adjusted value of the at least one processing parameter in the interaction interface; generating the processing preview diagram based on the adjusted value of the at least one processing parameter and the processing factor information; and displaying the processing preview diagram in the interaction interface.

In some implementations, in response to the selection operation performed on the processing preview diagram, determining the candidate parameter-value set corresponding to the selection operation to be the target parameter-value set includes: when no further adjustment operation is received through the parameter adjustment control within a preset time duration, determining a latest processing preview diagram corresponding to a latest adjustment operation; and in response to a selection operation performed on the latest processing preview diagram, determining the target parameter-value set including an adjusted value of the at least one processing parameter that is adjusted by the latest adjustment operation.

In some implementations, the processing factor information includes at least a material property of a test workpiece, and obtaining and displaying the processing preview diagram based on the processing factor information includes: in response to a processing test request, controlling the processing device to process the test workpiece based on the one or more candidate parameter-value sets, such that the one or more preview patterns are processed onto the test workpiece under the one or more candidate parameter-value sets, respectively; obtaining a captured image of the test workpiece that is formed with the one or more preview patterns; based on a recognition processing result of the captured image, identifying the one or more preview patterns in the captured image and identifying the one or more candidate parameter-value sets corresponding to the one or more preview patterns in the captured image, respectively; and generating and displaying the processing preview diagram corresponding to the material property of the test workpiece, where the processing preview diagram includes the one or more preview patterns corresponding to the one or more candidate parameter-value sets, respectively.

In some implementations, identifying the one or more preview patterns in the captured image and identifying the one or more candidate parameter-value sets corresponding to the one or more preview patterns in the captured image, respectively, includes: performing pattern- position recognition on the captured image to obtain one or more sets of position information corresponding to the one or more preview patterns, respectively; and performing parameter-value recognition on the one or more preview patterns in the captured image to obtain the one or more candidate parameter-value sets corresponding to the one or more preview patterns, respectively.

In some implementations, an identification model is applied to perform the pattern-position recognition and the parameter-value recognition. Identifying the one or more preview patterns in the captured image and identifying the one or more candidate parameter-value sets corresponding to the one or more preview patterns in the captured image, respectively, further includes: sending the captured image to a server, to cause the server to apply the identification model to perform the pattern-position recognition on the captured image to obtain the one or more sets of position information corresponding to the one or more preview patterns, respectively, and to perform the parameter-value recognition on the one or more preview patterns in the captured image to obtain the one or more candidate parameter-value sets corresponding to the one or more preview patterns, respectively; and receiving, from the server, the one or more sets of position information and the one or more candidate parameter-value sets corresponding to the one or more preview patterns.

In some implementations, in response to the processing test request, controlling the processing device to process the test workpiece based on the one or more candidate parameter-value sets includes: in response to an input of a material property of the test workpiece, displaying a processing interface including a processing control; in response to receiving a triggering operation through the processing control, generating the processing test request; and sending the processing test request to the processing device to cause the processing device to process the plurality of sample patterns onto the test workpiece.

In some implementations, the processing device includes: a slide rail; a processing platform including a processing area for placing the target workpiece; and a processing head movably provided on the slide rail. The processing head is controlled to move on the slide rail in the processing area to perform a manufacturing processing on the target workpiece based on the target parameter-value set. The manufacturing processing includes at least one of a laser processing, a cutting processing, or a printing processing.

In some implementations, the processing device further includes a housing and a cover plate. The housing and the cover plate are configured to enclose an inner space for accommodating the target workpiece to be processed. The housing has an opening that communicates with the inner space, and the cover plate is connected to the housing to expose or cover the opening. The cover plate includes a light-transmitting window. The slide rail, the processing head, and the processing platform are located in the inner space, and a camera device is provided in the inner space.

In some implementations, the processing method further includes: displaying a parameter sharing interface which comprises the target parameter-value set; in response to a sharing selection operation performed on the parameter sharing interface, using the target parameter-value set selected by the sharing selection operation as a shared parameter-value set, and using an entity selected by the sharing selection operation as a shared entity; and sending the shared parameter-value set to the shared entity.

In another aspect, a processing system includes a processing device and a terminal device. The processing device includes: a base plate including a processing area for placing a target workpiece to be processed; and a processing head configured to move in the processing area. The terminal device is communicatively coupled to the processing device and includes a processor configured to: receive processing factor information; obtain and display a processing preview diagram based on the processing factor information, where the processing preview diagram includes one or more preview patterns corresponding to one or more candidate parameter-value sets, respectively; in response to a selection operation performed on a first preview pattern from the one or more preview patterns, determine a first candidate parameter-value set corresponding to the first preview pattern to be a target parameter-value set; and control the processing device to process the target workpiece based on the target parameter-value set.

In yet another aspect, a non-transitory computer-readable storage medium having instructions stored thereon is disclosed. The instructions, when executed by at least one processor, cause the at least one processor to perform a processing method. The processing method includes: receiving processing factor information; obtaining and displaying a processing preview diagram based on the processing factor information, where the processing preview diagram includes one or more preview patterns corresponding to one or more candidate parameter-value sets, respectively; in response to a selection operation performed on a first preview pattern from the one or more preview patterns, determining a first candidate parameter-value set corresponding to the first preview pattern to be a target parameter-value set; and controlling a processing device to process a target workpiece based on the target parameter-value set.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 is a schematic structural diagram of a processing device according to some aspects of the present disclosure.

FIG. 2 is a block diagram of a processing system including a processing device and one or more terminal devices according to some aspects of the present disclosure.

FIG. 3 is a flowchart of a processing method according to some aspects of the present disclosure.

FIG. 4A is a flowchart of a method of obtaining and displaying a processing preview diagram according to some aspects of the present disclosure.

FIG. 4B is a flowchart of a method of determining a target parameter-value set according to some aspects of the present disclosure.

FIG. 5 shows an exemplary processing parameter matrix according to some aspects of the present disclosure.

FIG. 6 shows another exemplary processing parameter matrix according to some aspects of the present disclosure.

FIG. 7 shows an exemplary interaction interface for a hovering operation according to some aspects of the present disclosure.

FIG. 8 shows an exemplary interaction interface including a configuration panel according to some aspects of the present disclosure.

FIG. 9A is a flowchart of another method of obtaining and displaying a processing preview diagram according to some aspects of the present disclosure.

FIG. 9B is a flowchart of another method of determining a target parameter-value set according to some aspects of the present disclosure.

FIG. 10 shows another exemplary interaction interface including a configuration panel according to some aspects of the present disclosure.

FIG. 11 shows still another exemplary interaction interface including processing preview diagrams according to some aspects of the present disclosure.

FIG. 12A is a flowchart of still another method for obtaining and displaying a processing preview diagram according to some aspects of the present disclosure.

FIG. 12B shows an exemplary captured image according to some aspects of the present disclosure.

FIGS. 13A and 13B show an exemplary material-processing process performed by a terminal device, a processing device, and a server according to some aspects of the present disclosure.

FIGS. 14A-14E shows exemplary interaction interfaces for material processing according to some aspects of the present disclosure.

FIG. 15A shows a first sample image according to some aspects of the present disclosure.

FIG. 15B shows a second sample image according to some aspects of the present disclosure.

FIGS. 16A-16D show an identification process of a captured image according to some aspects of the present disclosure.

FIG. 17 shows a structure of an identification model according to some aspects of the present disclosure.

FIG. 18 shows a block diagram of a processing apparatus according to some aspects of the present disclosure.

FIG. 19 shows a block diagram of a computing device according to some aspects of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosure can be combined, adjusted, and modified with one another and in ways not specifically depicted in the drawings, such that these combinations, adjustments, and modifications are within the scope of the present disclosure.

The block diagrams shown in the figures are merely functional entities and do not necessarily correspond to physically independent entities. These functional entities can be implemented in the form of software, or in one or more hardware modules or integrated circuits, or in different networks and/or processing devices and/or microcontroller devices.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. In another example, the term “multiple” mentioned in the present disclosure may refer to two or more. “And/or” describes the associative relationship of associated objects, indicating that there can be three types of relationships, for example, A and/or B can mean: A exists alone, A and B exist together, or B exists alone.

Various processing devices such as laser engraving machines, computer numerical control (CNC) milling machines, or three-dimensional (3D) printers have been widely used in different areas such as industrial design, advertising production, artwork creation, etc. Although some processing devices can provide adjustments on processing parameters in a wide range to meet diverse processing needs, these parameter adjustments introduce complexity into the operation of the processing devices. For example, the numerous adjustable parameters and the broad adjustment ranges of these parameters may make it difficult for a user, especially a novice user who is new to such a device, to quickly find out desirable values for the different processing parameters. This parameter-value adjustment process may need to undergo repeated trials until the user finds out an optimal combination of the values of the processing parameters. This parameter-value adjustment process is not only time-consuming and labor-intensive but also inefficient, potentially resulting in the waste of the processing materials and an increase in the processing cost. For example, if there is a cognitive bias in the treatment of the processing materials, the parameter values configured by the user manually may fail to meet the product production need, resulting in the waste of the processing materials as well as the waste of time. Thus, the processing efficiency and the processing accuracy are decreased.

To address one or more of the of the aforementioned issues, the present disclosure introduces a target parameter-value determination process with the aid of a processing preview diagram, which can help a user to quickly identify a target parameter-value set. Consistent with some aspects of the present disclosure, processing factor information describing one or more processing factors (e.g., a material property of a target workpiece, a device type, or a processing type) can be obtained. A processing preview diagram can be obtained and displayed to a user through an interaction interface based on the processing factor information. The processing preview diagram may include one or more preview patterns corresponding to one or more candidate parameter-value sets, respectively. For example, the processing preview diagram can be a processing parameter matrix including one or more matrix elements, where each matrix element includes a corresponding preview pattern (e.g., having a predetermined shape such as an “X” shape), and indicates a corresponding candidate parameter-value set (e.g., including a corresponding scan speed value and a corresponding power value).

In some implementations, a mapping relationship exists between different processing preview diagrams and processing factors, and the processing parameter matrices are pre-stored in a database. Given the processing factor information, the processing preview diagram matching the processing factor information can be obtained from the database based on the mapping relationship. In some implementations, the processing preview diagram may be generated in real time based on the user's adjustment on the values of the processing parameters, as described below in more detail.

Then, through the interaction interface, the user can select a preview pattern from the one or more preview patterns in the processing preview diagram based on his/her actual need of the processing effect. A candidate parameter-value set corresponding to the selected preview pattern can be determined to be a target parameter-value set. Subsequently, a processing device can be controlled to process the target workpiece based on the target parameter-value set such that a target pattern can be formed on a target workpiece based on the target parameter-value set. The target workpiece can be an actual workpiece to be processed. The target pattern may be a pattern that the user would like to be processed onto the target workpiece, and may be the same as or different from the selected preview pattern but has the same or similar processing effect as the selected preview pattern.

Compared to existing technologies that require a user to debug a suitable value for each processing parameter individually and manually such that a desirable combination of the values of the processing parameters can be obtained, the target parameter-value determination process disclosed herein with the aid of the processing preview diagram can help the user to quickly identify the target parameter-value set. The target parameter-value set determined thereof may not only match the material property of the target workpiece to achieve a satisfactory processing effect, but also meet the actual processing need of the user. Therefore, the material-processing process can be simplified, the processing efficiency can be improved, and the user experience can be improved.

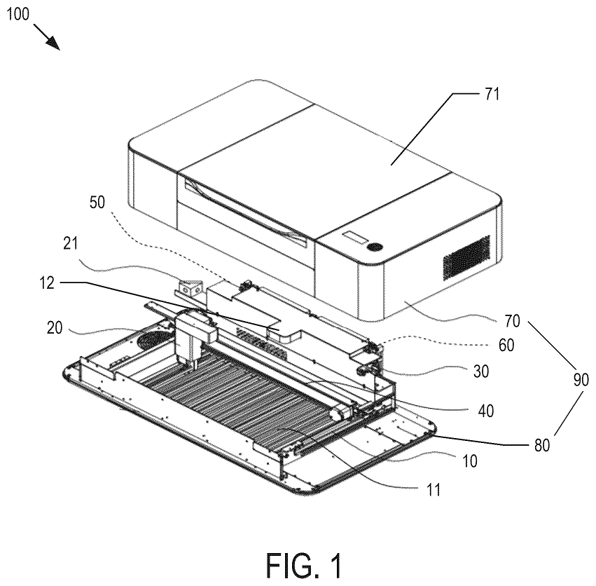

Consistent with some aspects of the present disclosure, the processing preview diagram may be obtained through a processing test on a test workpiece. For example, the processing preview diagram may be obtained at least by: (i) receiving the processing factor information describing one or more processing factors (e.g., a material property) associated with the test workpiece from a user; (ii) instructing the processing device (e.g., processing device 100 in FIG. 1) to process the test workpiece based on one or more candidate parameter-value sets and the processing factor information, such that one or more preview patterns corresponding to the one or more candidate parameter-value sets are formed on the test workpiece, respectively; (iii) capturing an image of the test workpiece with the one or more preview patterns formed thereon; (iv) performing a recognition process on the captured image to identify the one or more preview patterns and the one or more candidate parameter-value sets corresponding to the one or more preview patterns, respectively, from the captured image; and (v) generating the processing preview diagram to include the one or more preview patterns corresponding to the one or more candidate parameter-value sets. Then, a target parameter-value set can be determined from the processing preview diagram generated from the captured image. Afterwards, the processing device may be controlled to process a target workpiece based on the target parameter-value set. The target workpiece may have material similar to that of the test workpiece or may have the same material as the test workpiece, which is not limited herein.

By presenting the processing preview diagram generated through the processing test, the user can learn the processing effects of the different candidate parameter-value sets on the test workpiece and select the target parameter-value set with the desirable processing effect before the target workpiece is actually processed. As a result, potential processing defects, which may result in the waste of the processing materials as well as the waste of time, can be observed through the processing preview diagram from the processing test, and can therefore be avoided. The processing efficiency and the processing accuracy on the target workpiece are therefore improved.

It can be understood that throughout the present disclosure, when applying user-related data in the implementations disclosed herein, user permission or consent needs to be obtained. The collection, use, and/or processing of the user-related data need to comply with relevant laws, regulations, and standards of related countries and regions.

FIG. 1 is a schematic structural diagram of a processing device 100 according to some aspects of the present disclosure. Processing device 100 can be configured to perform a subtractive manufacturing operation (such as cutting or engraving) on processing materials using tools like lasers or cutters. Alternatively or additionally, processing device 100 may be configured to perform an additive manufacturing operation (such as printing) on processing materials. Examples of processing device 100 may include, but are not limited to, a laser processing device using laser as a means of processing, a CNC milling machine using a cutter as a means of processing, or an additive manufacturing device such as a 3D printer. A laser processing device may be a device that uses a laser beam for processing, and may be capable of conducting cutting, drilling, engraving, etc., or any other manufacturing operation on various materials such as metal, plastic, wood, glass, textiles, etc. For example, a laser processing device can be a laser engraver, a laser cutter, a laser printer, etc., which is not limited herein.

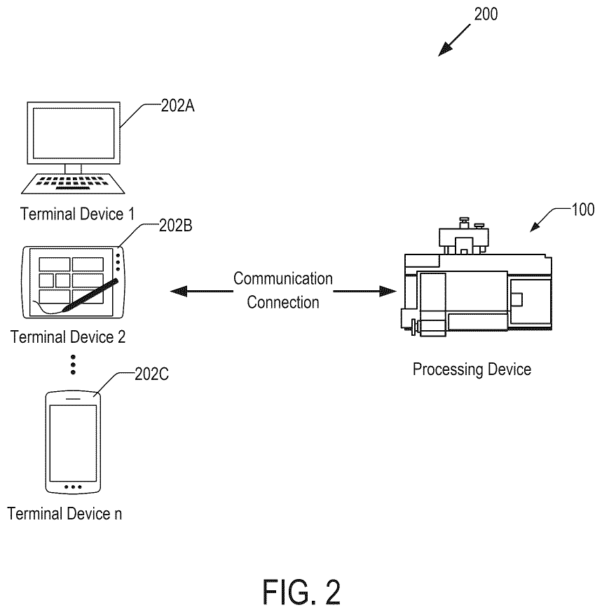

Consistent with some aspects of the present disclosure, processing device 100 may include a slide rail 40 and a processing head 20 configured to be movably provided on slide rail 40. Processing device 100 may also include a communication unit 50 configured to receive a parameter-value set (e.g., a target parameter-value set or a candidate parameter-value set), or any other suitable instructions or data, from a terminal device 202 (shown in FIG. 2). Processing device 100 may further include a controller 60 configured to control processing head 20 to move on slide rail 40 to process a workpiece based on the received parameter-value set. The processing on the workpiece may include laser processing, cutting processing, printing processing, or any other suitable subtractive or additive processing, which is not limited herein.

For illustration purposes only, a hardware structure of processing device 100 is described by taking a laser processing device as an example as illustrated in FIG. 1. Processing device 100 includes a housing 90, a processing platform 10, processing head 20, a laser tube 30, slide rail 40, communication unit 50, and controller 60. Housing 90 includes an upper shell 70 and a bottom shell 80. Processing platform 10 includes a processing area 11 for placing a workpiece to be processed (e.g., a target workpiece that a target pattern is intended to be processed onto, a test workpiece for a processing test, or a training workpiece for a model training purpose). Processing head 20 is configured to move on slide rail 40 within processing area 11 to perform processing on the workpiece.

Communication unit 50 is configured to receive a parameter-value set (e.g., a target parameter-value set, or a candidate parameter-value set) from a terminal device. The target parameter-value set and the candidate parameter-value set are described below in more detail. Controller 60 controls processing head 20 to move on slide rail 40 based on the received parameter-value set to process the workpiece. Communication unit 50 and controller 60 can be installed inside a back panel of laser tube 30, and are not visible from the perspective of FIG. 1 (shown with dotted leading lines in FIG. 1).

In some implementations, a reflecting mirror 21 is provided between processing head 20 and laser tube 30. A beam generated by laser tube 30 is reflected by reflecting mirror 21 to arrive at processing head 20, and then emits out to process the workpiece after reflection and focusing. In some implementations, processing head 20 can generate a light beam. In some other implementations, the light beam can be generated by other components such as laser tube 30 (including a CO₂ laser tube) and then enters a beam emitting device through reflecting mirror 21, and subsequently emits out through processing head 20 to process the workpiece. Processing head 20 can emit laser or any other suitable light, which is not limited herein.

In some implementations, in response to receiving a processing execution instruction, controller 60 may control processing head 20 to move on slide rail 40 to process the workpiece based on the received parameter-value set. For example, slide rail 40 can be a guide rail having an X-axis rail and/or a Y-axis rail, and the guide rail can include linear rails or rails with cooperative optical axes and rollers for sliding, as long as processing head 20 can be driven to move on the guide rail to process on the X-axis and/or Y-axis. In some implementations, slide rail 40 may also include a Z-axis rail such that processing head 20 may move in the Z direction along the Z-axis rail for adjusting focusing before and/or during processing. Therefore, processing head 20 can move within a range covered by slide rail 40 to perform at least one of laser processing, cutting processing, printing processing, etc., on the workpiece.

For different processing devices, processing heads 20 configured therein are also different. For example, for a processing device which uses laser as the processing means, its corresponding processing head 20 can be configured with a laser component for emitting laser to perform laser processing on the workpiece. For a processing device which uses a cutter as the processing means, its corresponding processing head 20 can be configured with a cutter to perform mechanical cutting processing on the workpiece. For a processing device which uses additive manufacturing as the processing means, its corresponding processing head 20 can be configured with an additive manufacturing component to perform additive processing (e.g., printing processing) on the workpiece to achieve additive manufacturing.

In some implementations, processing device 100 further includes a cover plate 71, where housing 90 and cover plate 71 may enclose an inner space for accommodating the workpiece to be processed. Housing 90 may include an opening that communicates with the inner space, and cover plate 71 is connected to housing 90 to expose or cover the opening. For example, when cover plate 71 is closed, the opening is covered by cover plate 71. When cover plate 71 is opened, the opening is exposed. Slide rail 40, processing head 20, and processing platform 10 are located in the inner space. A camera device 12 is also provided in the inner space, which can be used to film the processing process of the workpiece in the inner space and/or capture images of the workpiece in the inner space.

In some implementations, housing 90 can be an integrally formed housing or a housing formed by splitable components. For example, housing 90 may include upper shell 70 and bottom shell 80 that are detachably connected or fixedly connected, where upper shell 70 and bottom shell 80 enclose an inner space for accommodating the workpiece together with cover plate 71. Through the blocking and/or filtering effect of upper shell 70 and bottom shell 80, laser emitted by processing head 20 can be prevented from overflowing from the inner space during operation of processing head 20, thereby preventing the laser to cause harm to an operator.

In some implementations, cover plate 71 can be connected to housing 90 through a hinge, a slide rail connection approach, or any other suitable connection approach. For example, a hinge can be installed between cover plate 71 and housing 90, allowing cover plate 71 to be opened and closed like a door. In another example, a slide rail is provided between cover plate 71 and housing 90, allowing cover plate 71 to move along the slide rail to achieve relative movement with respect to housing 90. By sliding along the slide rail, cover plate 71 can cover or expose the opening.

The operator can open cover plate 71 to expose the opening, such that the workpiece can be placed into or taken out from the inner space through the opening. Or, the operator can close cover plate 71 to cover the opening, such that the inner space is sealed by cover plate 71. In some implementations, cover plate 71 includes a light-transmitting window (e.g., a transparent window), allowing the operator to observe the processing on the workpiece in the inner space through the light-transmitting window.

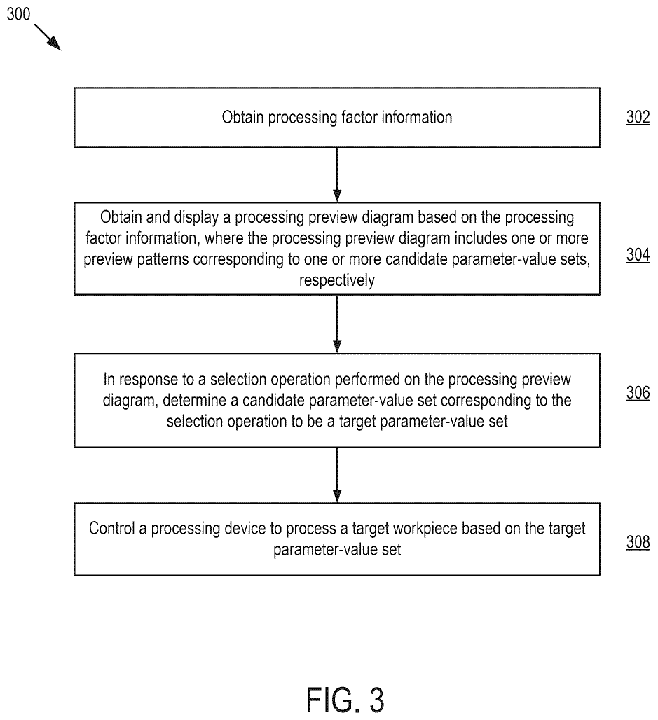

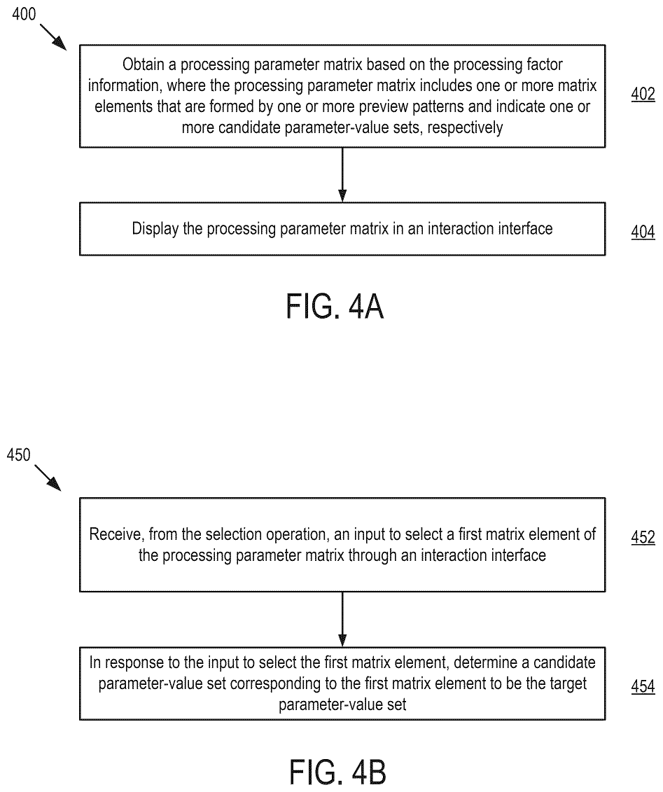

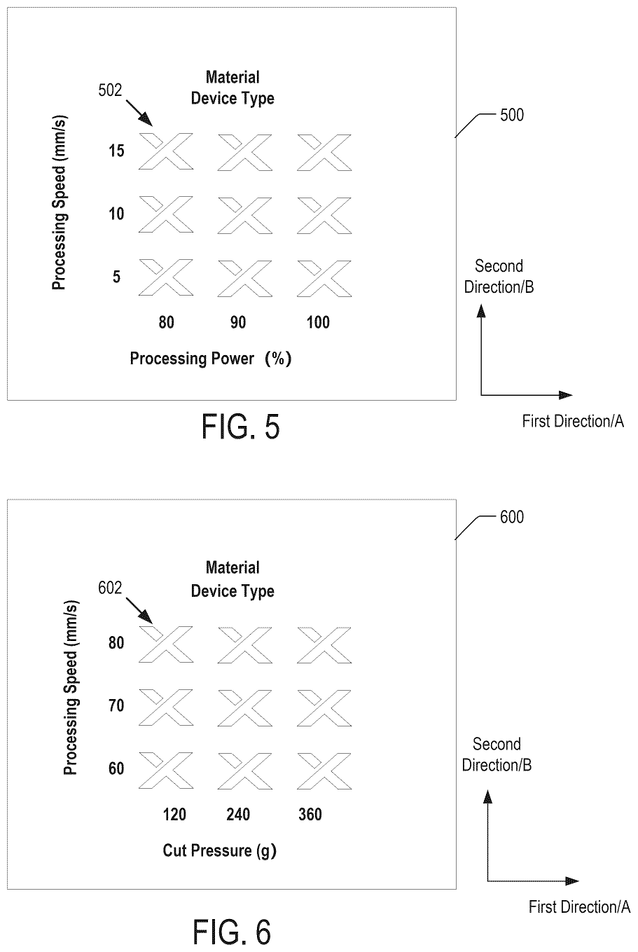

FIG. 2 is a block diagram of a processing system 200 according to some aspects of the present disclosure. Processing system 200 includes processing device 100 and one or more terminal devices 202A, 202B, 202C (also referred to as terminal device 202, collectively or individually) that are communicatively coupled with processing device 100. Terminal device 202 includes at least one processor and a memory in communication with the at least one processor. The memory stores instructions that are executable by the at least one processor. When the instructions are executed by the at least one processor, the at least one processor is caused to perform any of the methods disclosed herein (e.g., a processing method 300 shown in FIG. 3 or any other method shown in FIGS. 4A, 4B, 9A, 9B, 12A, or 13A-13B). Terminal device 202 can include, but is not limited to, a mobile phone, a laptop, a Personal Digital Assistant (PDA), a Portable Application Description (PAD), a desktop computer, a tablet computer, a television (TV), a wearable device such as a smart watch, etc.

Consistent with some aspects of the present disclosure, a processing application may be installed on terminal device 202 for providing an interaction interface to a user operating on terminal device 202, so that the user can control processing device 100 to perform processing actions through the interaction interface. For example, as described below in more detail, the interaction interface may be configured to present a processing preview diagram to the user, such that the user can intuitively learn the different processing effects of different candidate parameter-value sets through different preview patterns in the processing preview diagram and conveniently select a target parameter-value set based on the processing preview diagram. In another example, the interaction interface may include a parameter adjustment control for adjusting one or more values of one or more processing parameters. In still another example, the interaction interface may include a processing control, such that by triggering the processing control, a processing execution instruction may be sent to processing device 100 to cause processing device 100 to start processing a workpiece. Other exemplary interaction interfaces are described below in more detail. Through the interaction interface, the user can conveniently and efficiently control processing device 100 to perform any suitable processing on the workpiece to be processed.

FIG. 3 is a flowchart of a processing method 300 according to some aspects of the present disclosure. Processing method 300 may be performed by terminal device 202. It is understood that the operations shown in processing method 300 may not be exhaustive and that other operations can be performed as well before, after, or between any of the illustrated operations. Further, some of the operations may be performed simultaneously, or in a different order than that shown in FIG. 3.

Processing method 300 may begin with operation 302 in which processing factor information may be obtained. For example, processing factor information associated with a workpiece to be processed (e.g., a target workpiece) may be obtained. The processing factor information may include information describing one or more processing factors, including a material property of the workpiece (e.g., a material name, a material type, a material size, a material color, a material thickness, etc., of the workpiece), a device type of processing device 100 used to process the workpiece (e.g., a laser processing device, a CNC milling machine, or a 3D printing device), and/or a processing type used to process the workpiece (e.g., laser line engraving, laser cutting, laser fill engraving, tool cutting, inkjet printing, etc.).

In some implementations, the processing factor information can be provided by a user. For example, the user may provide an input to specify the processing factor information. In some implementations, the processing factor information can be obtained through communication with processing device 100. For example, processing device 100 may send (i) device information including a device type and a processing type of processing device 100 and/or (ii) material information of the workpiece being placed in processing area 11 of processing device 100 to terminal device 202, such that at least one of the material property, the device type, or the processing type can be obtained.

Processing method 300 may proceed to operation 304, in which a processing preview diagram may be obtained and displayed based on the processing factor information. The processing preview diagram includes one or more preview patterns corresponding to one or more candidate parameter-value sets, respectively. The processing preview diagram can provide a preview of different processing effects (represented by the different preview patterns) associated with different candidate parameter-value sets under the processing factor information. It is understood that there is a mapping relationship between the preview patterns and the candidate parameter-value sets. That is, under the same processing factor information, different processing parameter-value sets correspond to different preview patterns with different processing effects, respectively.

The processing preview diagram may be associated with one or more processing parameters, such as a processing speed, a processing power, and/or a cut pressure. A processing parameter can be an operation parameter of processing device 100, and may be determined based on the device type of processing device 100. By taking processing device 100 as a laser processing device as an example, a processing parameter may include a laser power, a scan speed, a beam diameter, a pulse frequency, a beam mode, a gas type and flow, a focal length, or a light source, etc. It is contemplated that the processing parameters associated with the processing preview diagram can be flexibly adjusted according to actual application scenarios.

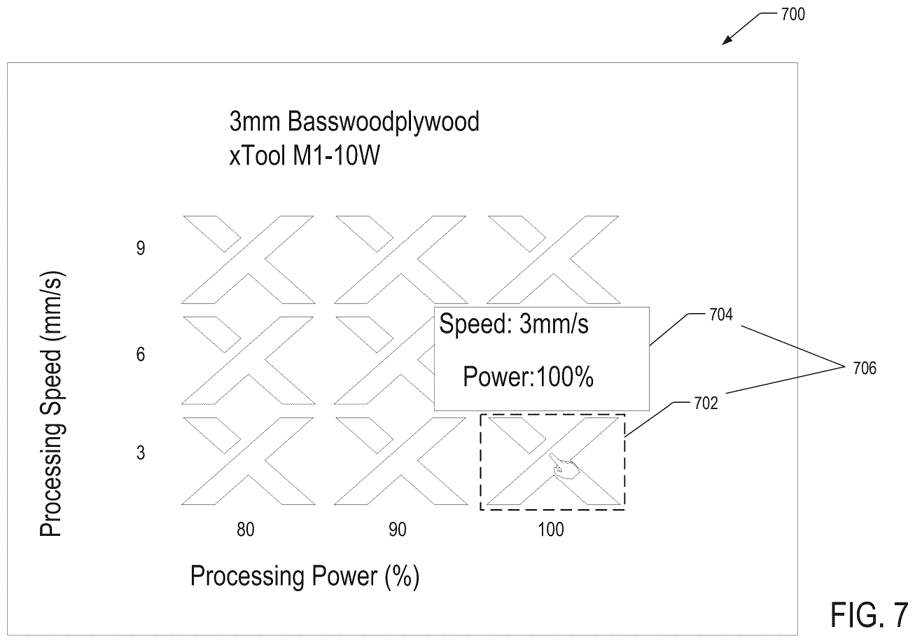

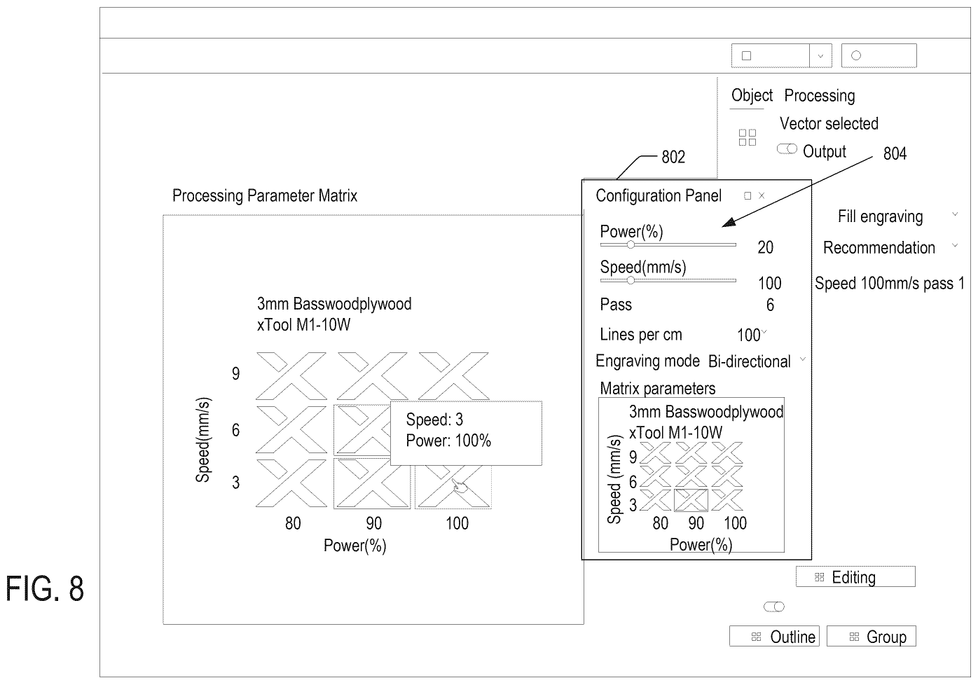

Each candidate parameter-value set may include one or more values for the one or more processing parameters, respectively. In a first example, referring to FIG. 5, a processing preview diagram is shown, which includes 3×3 preview patterns, with each preview pattern being formed with a corresponding candidate parameter-value set that includes a respective value of the processing speed and a respective value of the processing power. For instance, a preview pattern 502 at the upper left corner may be associated with a power value of 80% and a processing speed value of 15 mm/s. In a second example, referring to FIG. 6, a processing preview diagram is shown, which also includes 3×3 preview patterns, with each preview pattern being formed with a corresponding candidate parameter-value set that includes a respective value of the processing speed and a respective value of the cut pressure. For instance, a preview pattern 602 at the upper left corner may be associated with a processing speed value of 80 mm/s and a cut pressure value of 120 g.

Referring back to operation 304 of FIG. 3, in some implementations, the one or more candidate parameter-value sets for forming the one or more preview patterns in the processing preview diagram can be fixed (e.g., predetermined). The processing preview diagram can be obtained based on the one or more fixed candidate parameter-value sets. For example, the processing preview diagram can include a processing parameter matrix (e.g., as shown in FIGS. 5 and 6). The processing parameter matrix can be obtained according to the processing factor information and displayed in an interaction interface. The processing parameter matrix includes a plurality of matrix elements, with each matrix element formed by a respective preview pattern and indicates a respective candidate parameter-value set. As a result, the available candidate parameter-value sets can be directly and intuitively provided to a user through the preview patterns, to facilitate the user to understand the processing effects under the different candidate parameter- value sets in an easy way and to select the suitable candidate parameter-value set conveniently and efficiently.

Alternatively or additionally, the one or more candidate parameter-value sets for forming the one or more preview patterns in the processing preview diagram can be adjusted in real time. The processing preview diagram can be generated or updated based on the one or more real-time-adjusted candidate parameter-value sets. For example, an interaction interface including a configuration panel can be provided to a user, where the configuration panel at least includes a parameter adjustment control for adjusting the one or more values of the one or more processing parameters. Thus, in response to an adjustment operation performed through the parameter adjustment control, one or more adjusted values of the one or more processing parameters are displayed in the interaction interface. A processing preview diagram (e.g., including at least a preview pattern) corresponding to the one or more adjusted values of the one or more processing parameters is generated according to the processing factor information, and presented in the interaction interface. As a result, when the fixed candidate parameter-value sets fail to meet a user's processing need, values of the processing parameters can be adjusted in real time by the user, and a real-time processing preview diagram can be generated and provided to the user based on the real-time-adjusted values of the processing parameters. Therefore, different user needs can be fulfilled in real time, and the user experience can be improved.

Operation 304 is further described below in more detail with reference to FIGS. 4A, 9A, 12A, or 13A.

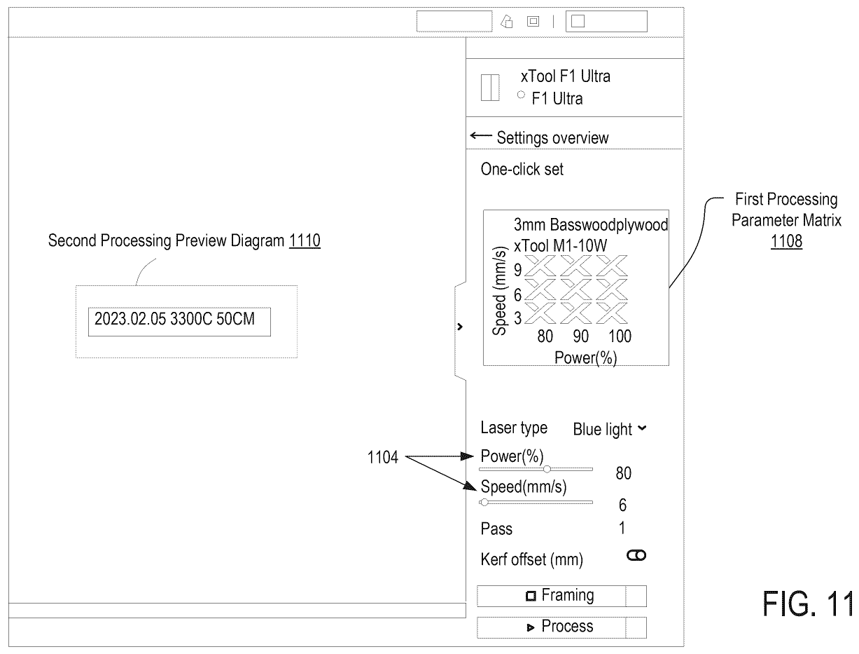

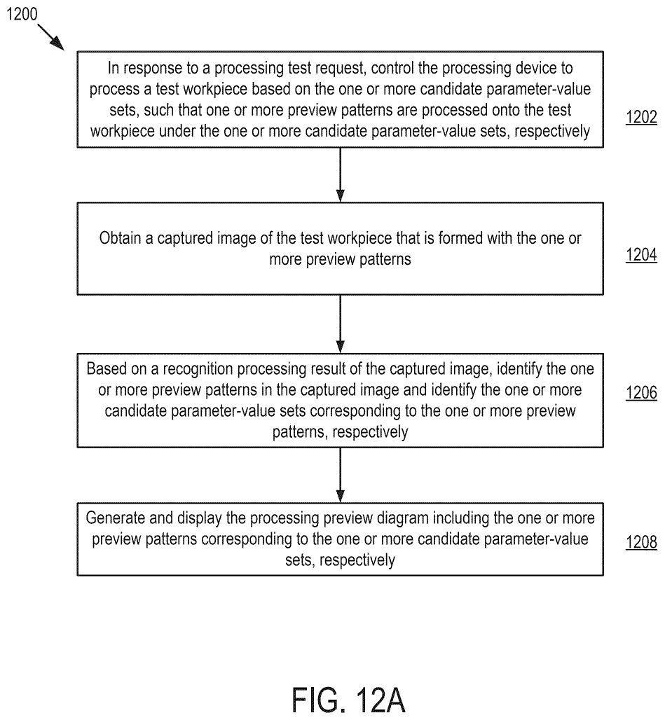

Processing method 300 may proceed to operation 306 in which, in response to a selection operation performed on the processing preview diagram, a candidate parameter-value set corresponding to the selection operation is determined to be a target parameter-value set. In some implementations, the selection operation can be performed on the processing preview diagram to select a particular preview pattern. For example, the selection operation includes, but is not limited to, a click, a double-click, or any other suitable operation representing the selection behavior on the particular preview pattern. A candidate parameter-value set corresponding to the selected preview pattern is selected to be the target parameter-value set. The target parameter-value set can be applied to process the workpiece, shared with other users, or saved for subsequent use, which is not limited herein. Operation 306 is further described below in more detail with reference to FIGS. 4B, 9B, or 13B.

Processing method 300 may proceed to operation 308, in which processing device 100 is controlled to process a target workpiece based on the target parameter-value set. In some implementations, in response to a parameter applying instruction associated with the target parameter-value set, a processing execution instruction can be generated. For example, a parameter applying instruction can be generated based on a user input that instructs or confirms the processing of the target workpiece. A processing execution instruction (e.g., a Gcode instruction) can be generated to include the target parameter-value set based on the parameter applying instruction.

Subsequently, the processing execution instruction can be sent to processing device 100 to instruct processing device 100 to process a target pattern onto the target workpiece based on the target parameter-value set. The target pattern can be a pattern that is intended to be processed onto the target workpiece. The target pattern may have the same design as or a different design from the selected preview pattern, but has the same or similar processing effect as the selected preview pattern.

In some implementations, processing method 300 may further include: (i) displaying a parameter sharing interface which includes the target parameter-value set; and (ii) in response to a sharing operation performed on the parameter sharing interface, sharing the target parameter-value set with one or more other entities. For example, the user may select the one or more other entities from a list (or inputting identity information about the one or more other entities), and then click on a share button in the parameter sharing interface, causing the target parameter-value set to be sent to the one or more other entities. In some implementations, the target parameter-value set may include a first value of a first processing parameter and a second value of a second processing parameter. At least one of the first value of the first processing parameter or the second value of the second processing parameter can be shared with the one or more other entities.

In some examples, at least one of the other entities can be another user, another terminal device 202, another processing device 100, a server, or any other suitable entity, which is not limited herein. In some examples, at least one of the other entities can be identified by a communication account such as an account of a social network application, an email address, or any other suitable communication account. In some examples, at least one of the other entities can be identified by a user account displayed in the parameter sharing interface.

For example, processing method 300 may further include: (i) displaying a parameter sharing interface which includes the target parameter-value set; (ii) in response to a sharing selection operation performed on the parameter sharing interface, using the target parameter-value set selected by the sharing selection operation as a shared parameter-value set, and using an entity selected by the sharing selection operation as a shared entity; and (iii) sending the shared parameter-value set to the shared entity.

Consistent with some aspects of the present disclosure, by sharing the target parameter-value set with other users in a material-processing community, the interaction among the users in the community can be increased, thereby facilitating the other users to quickly obtain the target parameter-value set for similar processing scenarios to improve processing efficiency.

FIG. 4A is a flowchart of a method 400 of obtaining and displaying a processing preview diagram according to some aspects of the present disclosure. FIG. 4B is a flowchart of a method 450 of determining a target parameter-value set according to some aspects of the present disclosure. Methods 400 and 450 may be performed by terminal device 202. It is understood that the operations shown in methods 400 and 450 may not be exhaustive and that other operations can be performed as well before, after, or between any of the illustrated operations. Further, some of the operations may be performed simultaneously, or in a different order than that shown in FIGS. 4A and 4B.

In some implementations, the processing preview diagram disclosed herein can include a processing parameter matrix. Method 400 can be an exemplary implementation of operation 304 in FIG. 3. Method 450 can be an exemplary implementation of operation 306 in FIG. 3.

Referring to FIG. 4A, method 400 may begin with operation 402 in which the processing parameter matrix may be obtained based on the processing factor information. The processing parameter matrix may include one or more matrix elements that are formed by one or more preview patterns and indicate one or more candidate parameter-value sets, respectively. For example, a mapping relationship exists between different processing parameter matrices and processing factors. The different processing parameter matrices can be stored in a database (e.g. a local database or a cloud database). Given the processing factor information describing one or more processing factors, a processing parameter matrix matching the processing factor information can be obtained from the database based on the mapping relationship.

Method 400 may proceed to operation 404 in which the processing parameter matrix is displayed in an interaction interface.

Referring to FIG. 4B, method 450 may begin with operation 452 in which an input to select a first matrix element of the processing parameter matrix is received from a selection operation through an interaction interface.

Method 450 may proceed to operation 454 in which, in response to the input to select the first matrix element, a candidate parameter-value set corresponding to the first matrix element is determined to be the target parameter-value set.

With combined reference to FIGS. 4A and 4B, by presenting the processing parameter matrix with different matrix elements, a user can intuitively understand the processing effects of the different matrix elements corresponding to different candidate parameter-value sets. Then, the user can select a matrix element that meets his/her need of a particular processing effect from the processing parameter matrix, and then a candidate parameter-value set corresponding to the selected matrix element can be set as the target parameter-value set. As a result, the efficiency for determining the target parameter-value set can be improved, facilitating the user to obtain a target workpiece with a satisfactory processing effect similar to that of the selected matrix element.

Consistent with some aspects of the present disclosure, the processing parameter matrix can be a one-dimensional (1D) array, in which different matrix elements being arranged in one dimension may indicate different values of a processing parameter, respectively. For example, different matrix elements may differ only in the values of the processing power (e.g., while having the same value for the processing speed). In another example, different matrix elements may differ only in the values of the processing speed (e.g., while having the same value for the processing power). In this case, each matrix element in the processing parameter matrix may include a preview pattern formed by a respective candidate parameter-value set, where the respective candidate parameter-value set may include a different value for the processing parameter (e.g., while having the same value for another processing parameter).

Consistent with some aspects of the present disclosure, the processing parameter matrix can be a two-dimensional (2D) array, in which different matrix elements in two dimensions may indicate different first values of a first processing parameter and/or different second values of a second processing parameter, respectively. For example, each matrix element may indicate a respective first value of the first processing parameter and a respective second value of the second processing parameter. It is contemplated that the processing parameter matrix can also be an array with three or more dimensions, in which different matrix elements in three or more dimensions may indicate different values of three or more processing parameters, respectively.

By taking a 2D array as an example, FIGS. 5 and 6 respectively illustrate two processing parameter matrices 500 and 600 having two dimensions. Processing parameter matrix 500 in FIG. 5 may be applied when processing device 100 uses laser as a processing means, whereas processing parameter matrix 600 in FIG. 6 may be applied when processing device 100 uses a cutter as a processing means. Each processing parameter matrix 500 or 600 includes values of a first processing parameter in a first dimension and values of a second processing parameter in a second dimension. For example, referring to FIG. 5, each matrix element of processing parameter matrix 500 may include a first value for the processing power in the A-axis and a second value for the processing speed in the B-axis. Each matrix element in processing parameter matrix 500 may include a preview pattern having a shape of “X” formed by a respective candidate parameter-value set, where the respective candidate parameter-value set may include a respective first value for the processing power and a respective second value for the processing speed. In other words, each matrix element may indicate the respective candidate parameter-value set, and the corresponding processing effect of the matrix element is shown by the corresponding preview pattern “X.”

In another example, referring to FIG. 6, each matrix element of processing parameter matrix 600 may include a first value for the cut pressure in the A-axis and a second value for the processing speed in the B-axis. Each matrix element in processing parameter matrix 600 may include a preview pattern “X” formed by a respective candidate parameter-value set, where the respective candidate parameter-value set may include a respective first value for the cut pressure and a respective second value for the processing speed.

Processing parameter matrix 500 or 600 may also include processing factor information such as a material property, a device type, or a processing type. A user may check whether the processing factor information is correct from processing parameter matrix 500 or 600. Processing parameter matrix 500 or 600 may also include other processing information, which is not limited herein. Although each preview pattern is shown to have an X shape in FIGS. 5 and 6, it should be understood that the preview pattern can have any suitable shape such as a circular shape, a rectangular shape, etc., which is not limited herein.

Referring back to FIG. 4A, in some implementations, the processing parameter matrix may be associated with a first processing parameter and a second processing parameter (e.g., the processing parameter matrix being a 2D array with the first and second processing parameters as two dimensions). Each matrix element may indicate a candidate parameter-value set including a first value for the first processing parameter and a second value for the second processing parameter. Prior to operation 402 of FIG. 4A, method 400 may further include generating the processing parameter matrix at least by: (i) determining a first sorting position of each matrix element in a first direction (e.g., in a first dimension) based on a corresponding first value of the first processing parameter associated with the corresponding matrix element; (ii) determining a second sorting position of each matrix element in a second direction (e.g., in a second dimension) based on a corresponding second value of the second processing parameter associated with the corresponding matrix element; and (iii) arranging each matrix element in the processing parameter matrix based on the first sorting position and the second sorting position of the corresponding matrix element.

In some implementations, the first sorting positions of different matrix elements can be determined in an ascending order, i.e., a matrix element having a larger first value of the first processing parameter can have a larger first sorting position in the first direction like that shown in FIG. 5 or 6. Alternatively, the first sorting positions of different matrix elements can be determined in a descending order, i.e., a matrix element having a larger first value of the first processing parameter can have a smaller first sorting position in the first direction. Similarly, the second sorting positions of different matrix elements can be determined in an ascending order, i.e., a matrix element having a larger second value of the second processing parameter can have a larger second sorting position in the second direction like that shown in FIG. 5 or 6. Alternatively, the second sorting positions of different matrix elements can be determined in a descending order, i.e., a matrix element having a larger second value of the second processing parameter can have a smaller second sorting position in the second direction.

In some implementations, prior to operation 402 of FIG. 4A, method 400 may further include generating the processing parameter matrix based on a test result from a processing test. For example, to generate the processing parameter matrix, method 400 may further include one or more of the following steps: (i) selecting at least one processing parameter and at least one candidate value range of the at least one processing parameter; (ii) given one or more processing factors, performing a processing test based on the at least one processing parameter and the at least one candidate value range to obtain a test result corresponding to the one or more processing factors, where the one or more processing factors includes at least one of a material property of the workpiece to be processed, a device type, or a processing type; (iii) adjusting the at least one candidate value range based on the test result to obtain at least one target value range of the at least one processing parameter corresponding to the one or more processing factors; and (iv) by using the at least one processing parameter as at least one dimension of the processing parameter matrix, selecting one or more values from the at least one target value range to form one or more matrix elements of the processing parameter matrix, respectively. One or more candidate parameter-value sets corresponding to the one or more matrix elements may include the one or more values of the at least one processing parameter, respectively.

In some implementations, the test result may include a processing performance of the workpiece obtained under the given processing factors, where the processing performance includes at least a surface effect of the processed workpiece. The at least one target value range of the at least one processing parameter can be a part of the at least one candidate value range having the best surface effect of the processed workpiece. The method of selecting the one or more values of the at least one processing parameter from the at least one target value range can be random selection, equidistant selection, or selection of a predetermined number of values with the best surface effect, which is not limited herein.

In some implementations, with respect to the above step (iv), to select the one or more values from the at least one target value range to form the one or more matrix elements of the processing parameter matrix, method 400 may further include: (a) generating one or more preview patterns based on the one or more candidate parameter-value sets and the processing factor information; and (b) using the one or more preview patterns and the one or more candidate parameter-value sets to form the one or more matrix elements, respectively. As a result, the processing parameter matrix can be formed.

For example, if the test result includes a post-processing image corresponding to a particular candidate parameter-value set and the processing factor information, the post-processing image can be processed (e.g., by an identification model) to identify and extract a preview pattern in the image that matches the particular candidate parameter-value set and the processing factor information. The preview pattern may have a predetermined shape (such as an X shape, a circular shape, a rectangular shape, etc.). The identified preview pattern and the particular candidate parameter-value set can be used to form a matrix element of the processing parameter matrix.

In another example, if the test result does not include such a post-processing image, another processing test can be performed based on the particular candidate parameter-value set and the processing factor information to obtain such a post-processing image. Alternatively, a simulation can be performed to obtain such a post-processing image corresponding to the particular candidate parameter-value set and the processing factor information. Then, the post-processing image can be processed (e.g., by an identification model) to identify and extract the preview pattern that matches the particular candidate parameter-value set and the processing factor information. The identified preview pattern and the particular candidate parameter-value set can be used to form a matrix element of the processing parameter matrix.

In some implementations, following the above step (iv), method 400 may further include storing the processing parameter matrix as well as a mapping relationship between the one or more processing factors and the processing parameter matrices in a database (e.g., a local database or in a cloud database). In some examples, the database storing the processing parameter matrices can be accessed through embedded sites or external browsers.

In some implementations, the processing factor information describes at least one of a material property, a device type, or a processing type. Operation 402 of method 400 may include: (i) obtaining a mapping table that describes a mapping relationship between processing factors and processing parameter matrices; and (ii) querying the mapping table to obtain the processing parameter matrix that matches the at least one of the material property, the device type, or the processing type. For example, the processing factor information includes a material property of the workpiece. A processing parameter matrix matching the material property can be obtained from the database based on the mapping table. In another example, the processing factor information includes the material property of the workpiece and a processing device type. A processing parameter matrix matching the material property and the processing device type can be obtained from the database based on the mapping table. In still another example, the processing factor information includes the material property of the workpiece and a processing type. A processing parameter matrix matching the material property and the processing type can be obtained from the database based on the mapping table. In yet another example, the processing factor information includes the material property of the workpiece, the processing device type, and the processing type. A processing parameter matrix matching the material property, the processing device type, and the processing type can be obtained from the database based on the mapping table.

In some implementations, operation 402 of method 400 further includes sending the processing factor information to a server, such that the server obtains the processing parameter matrix based on the processing factor information and feeds back the processing parameter matrix. The server can be, for example, a cloud server or a local server, which is not limited herein. By obtaining the processing parameter matrix from the server, computing resources on terminal device 202 can be saved (or the demand on computing resources on terminal device 202 can be lowered), when compared to generating the processing parameter matrix locally on terminal device 202. The computing efficiency of terminal device 202 can be improved. The efficiency of determining the target parameter-value set can also be improved.

Also referring to FIG. 4A, in some implementations, operation 404 of method 400 may further include: (i) displaying a configuration panel (e.g., a processing parameter configuration panel) in the interaction interface, where the configuration panel includes the processing parameter matrix; (ii) in response to a click operation on the processing parameter matrix, enlarging the processing parameter matrix and displaying the enlarged processing parameter matrix in the interaction interface. That is, a user can preview the processing parameter matrix on the configuration panel. After determining that the presented processing parameter matrix meets his/her need, the user can click on the processing parameter matrix on the configuration panel to obtain an enlarged view of the processing parameter matrix in the interaction interface, thereby enhancing the display effect of the processing parameter matrix.

Referring to FIG. 4B, in some implementations, the processing parameter matrix can be in an image format and shown in an interaction interface. When a user moves an operation pointer (e.g., a mouse pointer) to a certain matrix element of the processing parameter matrix, if no feedback is provided to the user, the user may find it difficult to intuitively know whether the matrix element is selectable. To address this issue, method 450 of FIG. 4B may further include providing a hovering identification image in response to a hovering operation over the matrix element. This provides the user with intuitive feedback even if the processing parameter matrix is in the image format, thereby effectively improving the user's intuitive understanding of selecting a particular matrix element.

Specifically, prior to operation 452 of FIG. 4B, method 450 may further include: (i) in response to a hovering operation performed on the processing parameter matrix, obtaining a relative position of the hovering operation with respect to the processing parameter matrix; (ii) based on the relative position of the hovering operation, determining that the hovering operation points to a matrix element in the processing parameter matrix, and determining a position of the matrix element pointed to by the hovering operation; and (iii) displaying a hovering identification image at the position of the matrix element. The hovering identification image may include at least one of (i) an identification effect diagram matching a pattern size of the matrix element or (ii) a corresponding candidate parameter-value set indicated by the matrix element.

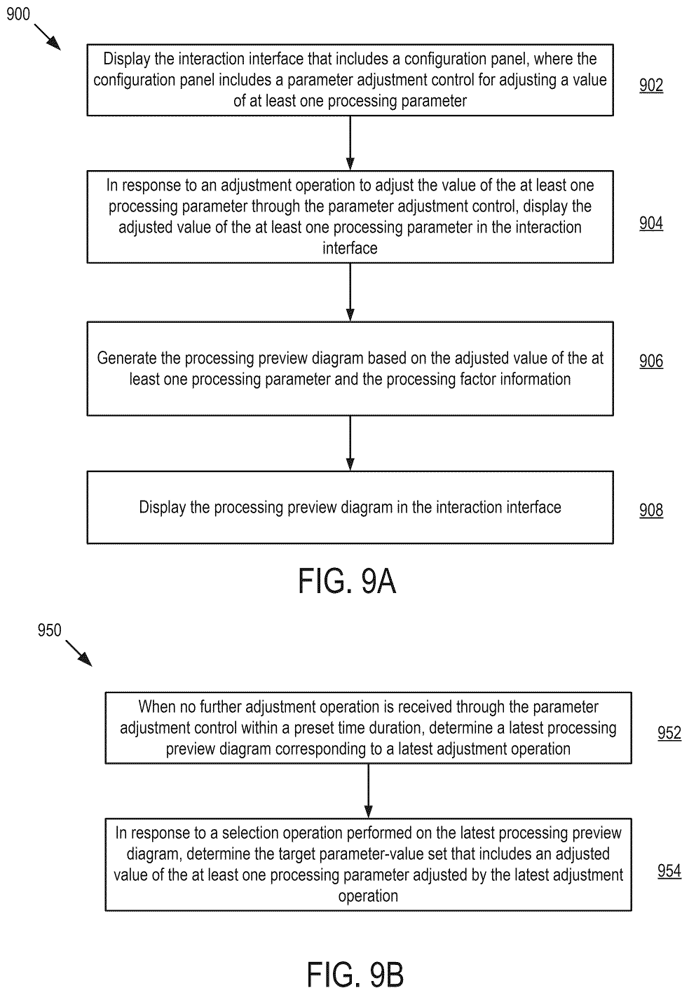

The hovering operation can be an operation that moves an operation pointer over a matrix element and temporarily stays over the matrix element without clicking on the matrix element. The hovering identification image can be an effect graph used to identify the hovering operation, such as a box framing out the matrix element using a different color. For example, referring to FIG. 7, a hovering operation is performed over a matrix element located at the lower right corner of a processing parameter matrix 700. A hovering identification image 706 is displayed at a position of the matrix element. Hovering identification image 706 may include (1) an effect graph 702 (a box with dashed lines shown in FIG. 7) matching a pattern size of the matrix element and (2) a candidate parameter-value set 704 indicated by the matrix element.

In some implementations, to ensure that the size of the hovering identification image matches the matrix element pointed to by the hovering operation, an mmTOpx (millimeter to pixel conversion) method can be used to convert the original graphical representation of the hovering identification image into the pixel form, so as to avoid the difficulty in matching the size of the pattern of the matrix element due to changes in screen specifications on different display devices. The mmTOpx method can be expressed as a JavaScript function as follows:

const mmtoPx = (mm: number, width: number) => {
return ‘${mm * (width / 180)}px‘
}

In the above function, “mm” represents the size of each hovering identification image, and “width” represents the size of the processing parameter matrix.

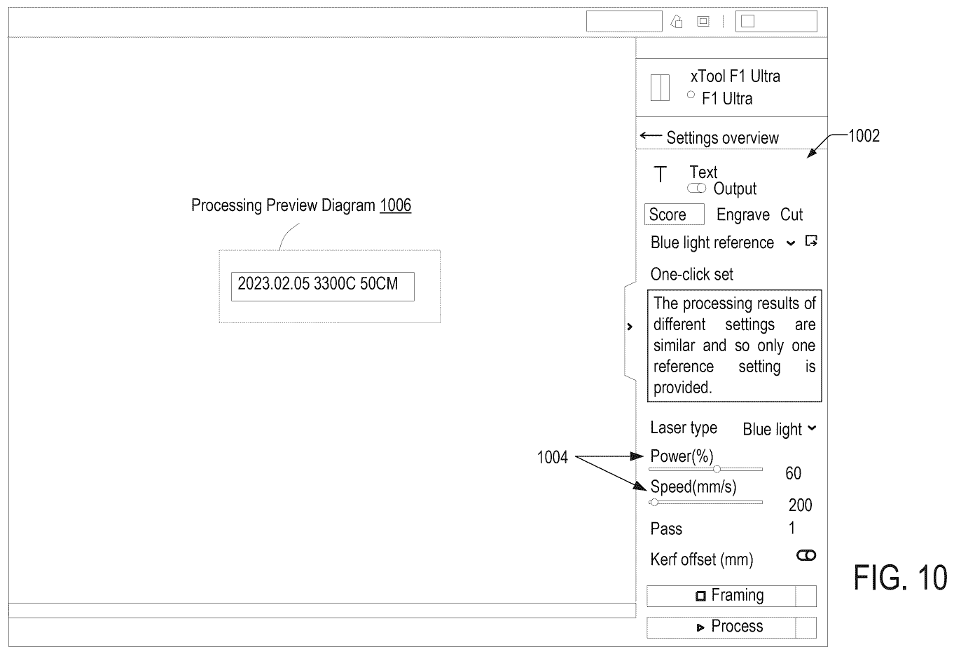

In some implementations, the interaction interface further displays a configuration panel (e.g., a processing parameter configuration panel) which includes a parameter adjustment control for adjusting values of the processing parameters. After operation 454 in which the target parameter-value set is determined, method 450 may further include: in response to an adjustment operation to adjust a value of a processing parameter in the target parameter-value set through the parameter adjustment control, updating the target parameter-value set based on the adjusted value of the processing parameter. For example, as shown in FIG. 8, the interaction interface further displays a configuration panel 802 which includes at least a parameter adjustment control 804. Parameter adjustment control 804 allows a user to adjust the target parameter-value set. For example, the value of the processing power and/or the value of the processing speed in the target parameter-value set can be adjusted through parameter adjustment control 804. That is, after selecting the target parameter-value set, a user can also adjust the selected target parameter-value set to make the target parameter-value set more closely meet his/her processing need.

Additionally, after updating the target parameter-value set, method 450 of FIG. 4B may further include: generating an updated processing preview diagram based on the updated target parameter-value set and the processing factor information; and displaying the updated processing preview diagram in the interaction interface. That is, since the target parameter-value set is newly updated, the processing preview diagram may also need to be updated to match or reflect the processing effect of the updated target parameter-value set. By generating and displaying the updated processing preview diagram in real-time according to the user's adjustment of the targe parameter-value set, the user can intuitively understand the processing effect corresponding to the updated target parameter-value set, thereby greatly improving the efficiency of target parameter value selection to meet the user's processing need and making it easier for the user to obtain the target workpiece with a satisfactory processing effect.

In some implementations, the updated processing preview diagram can be generated by simulation according to the target parameter-value set and the processing factor information. For example, if a user expects to engrave a pattern of a cat on a target workpiece, the engraving effect of the cat pattern on the target workpiece can be obtained through simulation based on the target parameter-value set and the processing factor information.

In some implementations, a post-processing image which matches the updated target parameter-value set and the processing factor information can be obtained by searching a processing effect image library. The processing effect image library can be a database pre-stored with post-processing images obtained under different parameter-value sets and processing factors. Then, the obtained post-processing image can be processed by an identification model to identify and extract an updated preview pattern that matches the updated target parameter-value set and the processing factor information. Then, the updated processing preview diagram may be generated to include the updated preview pattern corresponding to the updated target parameter-value set. The identification model is described below in more detail.

In some implementations, a post-processing image which matches the updated target parameter-value set and the processing factor information can be obtained through simulation. Then, the post-processing image can be processed by an identification model to identify and extract an updated preview pattern that matches the updated target parameter-value set and the processing factor information. Then, the updated processing preview diagram may be generated to include the updated preview pattern corresponding to the updated target parameter-value set.

Consistent with some aspects of the present disclosure, the processing parameter matrix may be obtained from a server. The target parameter-value set can be determined through an embedded site, and a “webCommandMaterial” event may be sent to processing device 100. When processing device 100 listens to the “webCommandMaterial” event, and successfully receives the “webCommandMaterial” event, processing device 100 can use a receiving interface to receive the target parameter-value set, and then process the workpiece according to the target parameter-value set. In some implementations, a custom protocol may be applied to awaken processing device 100. After processing device 100 is started, the processing factor information is loaded locally through the “webCommandMaterial” event, and a database storing the processing preview diagram is accessed through an external browser to obtain the processing preview diagram.

FIG. 9A is a flowchart of another method 900 of obtaining and displaying a processing preview diagram according to some aspects of the present disclosure. FIG. 9B is a flowchart of another method 950 of determining a target parameter-value set according to some aspects of the present disclosure. Method 900 can be an exemplary implementation of operation 304 of FIG. 3. Method 950 can be an exemplary implementation of operation 306 of FIG. 3. Methods 900 and 950 may be performed by terminal device 202. It is understood that the operations shown in methods 900 and 950 may not be exhaustive and that other operations can be performed as well before, after, or between any of the illustrated operations. Further, some of the operations may be performed simultaneously, or in a different order than that shown in FIGS. 9A and 9B.

Referring to FIG. 9A, method 900 may begin with operation 902 in which an interaction interface that includes a configuration panel can be displayed, where the configuration panel includes a parameter adjustment control for adjusting a value of at least one processing parameter. Method 900 may proceed to operation 904 in which, in response to an adjustment operation to adjust the value of the at least one processing parameter through the parameter adjustment control, the adjusted value of the at least one processing parameter can be displayed in the interaction interface. Method 900 may proceed to operation 906 in which the processing preview diagram can be generated based on the adjusted value of the at least one processing parameter and the processing factor information. Method 900 may proceed to operation 908 in which the processing preview diagram can be displayed in the interaction interface.

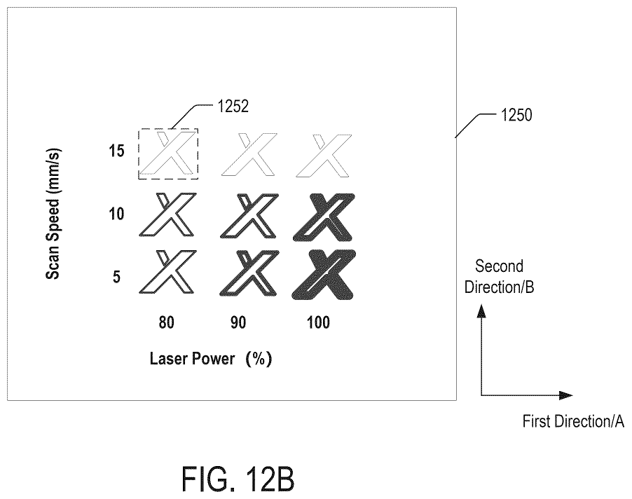

For example, referring to FIG. 10, the interaction interface displays a configuration panel 1002 which includes at least a parameter adjustment control 1004. Parameter adjustment control 1004 allows a user to adjust a candidate parameter-value set. For example, the value of the processing power and the value of the processing speed in the candidate parameter-value set can be adjusted through parameter adjustment control 1004. A processing preview diagram 1006 corresponding to the adjusted candidate parameter-value set is generated and displayed in the interaction interface. For example, processing preview diagram 1006 has a processing effect produced by the adjusted candidate parameter-value set.

Referring back to FIG. 9A, in some implementations, the processing preview diagram can be generated by simulation according to the adjusted candidate parameter-value set and the processing factor information. For example, if a user expects to engrave a pattern of a cat on the target workpiece, the engraving effect of the cat pattern on the target workpiece can be obtained through simulation based on the adjusted candidate parameter-value set and the processing factor information.

In some implementations, a post-processing image which matches the adjusted candidate parameter-value set and the processing factor information can be obtained by searching a processing effect image library. The processing effect image library can be a database pre-stored with post-processing images obtained under different parameter-value sets and processing factors. Then, the post-processing image can be processed by an identification model to identify and extract a preview pattern that matches the adjusted candidate parameter-value set and the processing factor information. The processing preview diagram may be generated to include the preview pattern corresponding to the adjusted candidate parameter-value set.

In some implementations, a post-processing image which matches the adjusted candidate parameter-value set and the processing factor information can be obtained through simulation. Then, the post-processing image can be processed by an identification model to identify and extract a preview pattern that matches the adjusted candidate parameter-value set and the processing factor information. The processing preview diagram may be generated to include the preview pattern corresponding to the adjusted candidate parameter-value set.

Referring to FIG. 9B, method 950 may begin with operation 952 in which when no further adjustment operation is received through the parameter adjustment control within a preset time duration, a latest processing preview diagram corresponding to a latest adjustment operation is determined. The preset time duration can be any suitable time period such as 5 s, 8 s, 10 s, etc., which is not limited herein. Method 950 may proceed to operation 954 in which, in response to a selection operation performed on the latest processing preview diagram (e.g., in response to a preview pattern in the latest processing preview diagram being selected), the target parameter- value set is determined to include an adjusted value of the at least one processing parameter adjusted by the latest adjustment operation.

With combined reference to FIGS. 9A and 9B, the processing preview diagram can be changed in real time according to the user's adjustment on the value of the at least one processing parameter. The presentation of this timely-updated processing preview diagram can greatly improve the efficiency of selecting the target parameter-value set that meets the user's needs, and make it easier for the user to obtain a target workpiece with a satisfactory processing effect.

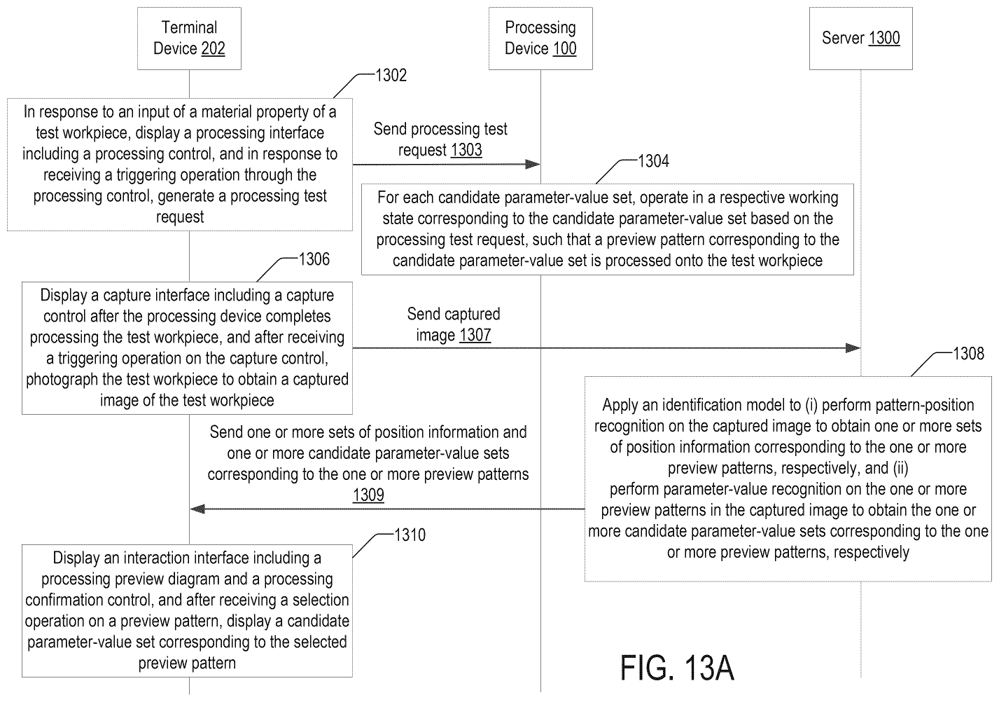

Consistent with some aspects of the present disclosure, referring to FIG. 11, a first processing preview diagram 1108 including one or more preview patterns corresponding to one or more fixed candidate parameter-value sets can be initially presented to a user (e.g., by performing operations described above with reference to operations 402 and 404 of FIG. 4A). If the one or more preview patterns fail to fulfill the user's processing need, then the user can adjust the value of at least one processing parameter through a parameter adjustment control 1104. Then, a second processing preview diagram 1110 can be generated based on the adjusted value of the at least one processing parameter and the processing factor information, and presented to the user (e.g., by performing operations described above with reference to operations 906 and 908 of FIG. 9A). As a result, the user may select second processing preview diagram 1110 that satisfies his/her processing need, and the target parameter-value set can be obtained thereof (e.g., by performing operations described above with reference to operations 952 and 954 of FIG. 9B).

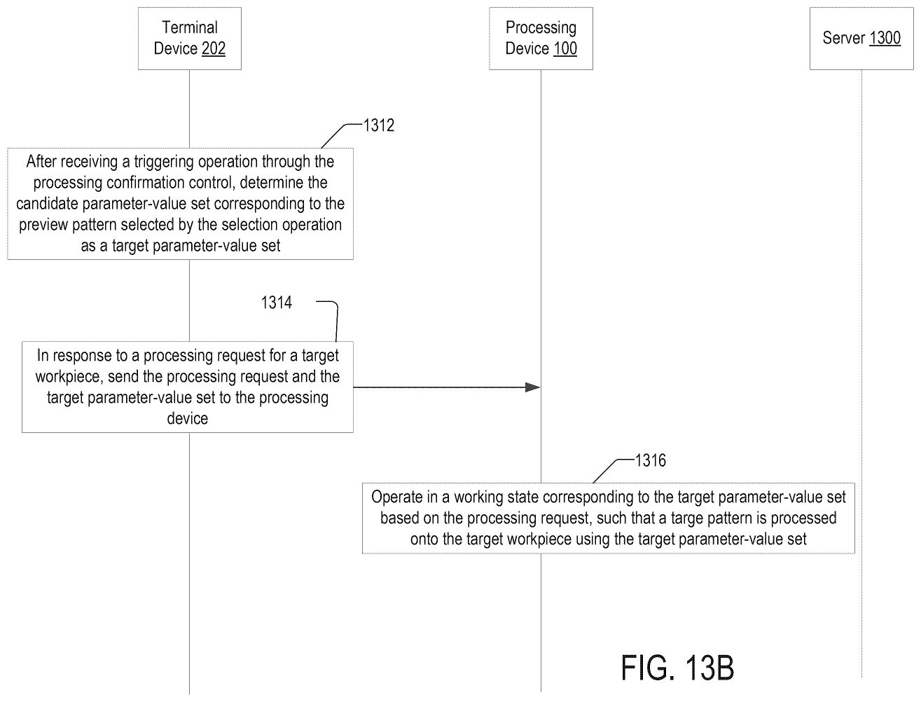

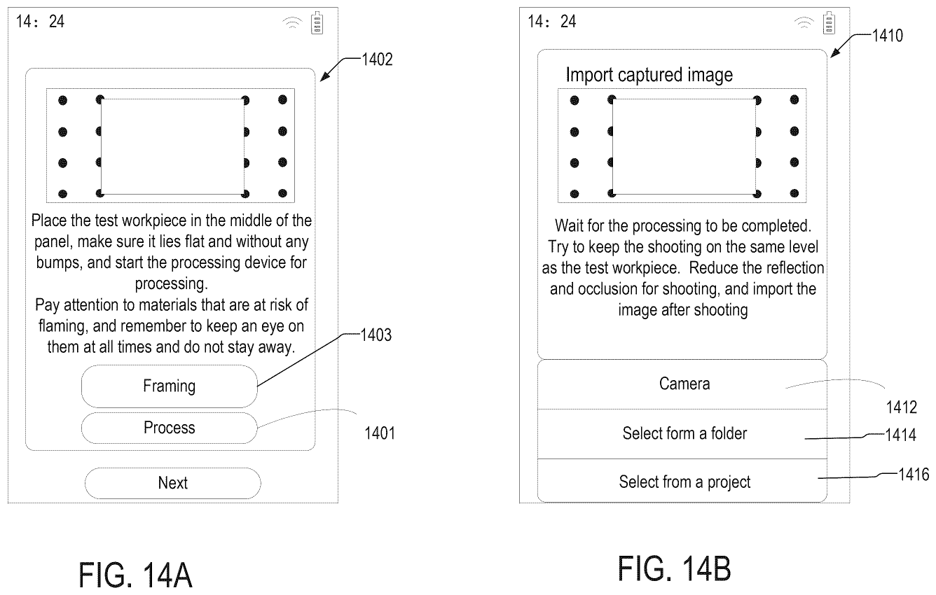

Consistent with some aspects of the present disclosure, the processing preview diagram (e.g., a processing parameter matrix) may be obtained through a processing test on a test workpiece. For example, the processing preview diagram may be obtained at least by: (i) receiving processing factor information describing one or more processing factors (e.g., a material property) associated with the test workpiece; (ii) instructing processing device 100 to process the test workpiece based on one or more candidate parameter-value sets and the processing factor information, such that one or more preview patterns corresponding to the one or more candidate parameter-value sets are formed on the test workpiece, respectively; (iii) capturing an image of the test workpiece with the one or more preview patterns formed thereon; (iv) performing an image identification process on the captured image to identify the one or more preview patterns and the one or more candidate parameter-value sets respectively corresponding to the one or more preview patterns from the captured image; and (v) generating the processing preview diagram to include the one or more preview patterns corresponding to the one or more candidate parameter-value sets. Subsequently, a target parameter-value set can be determined from the processing preview diagram obtained from the processing test on the test workpiece. For example, operations like those described above with reference to operation 306 of FIG. 3, method 450 of FIG. 4B, or operations described above with reference to FIG. 11 can be performed to determine the target parameter- value set. Afterwards, processing device 100 may be controlled to process a target workpiece based on the target parameter-value set. The target workpiece can be an actual workpiece to be processed. For example, the target workpiece may have a material similar to that of the test workpiece or have the same material as the test workpiece. An exemplary method for obtaining the processing preview diagram from the processing test is described below in more detail with reference to FIG. 12A.

FIG. 12A is a flowchart of still another method 1200 for obtaining and displaying a processing preview diagram according to some aspects of the present disclosure. Method 1200 may be performed by terminal device 202. Method 1200 may be an exemplary implementation of operation 304 of FIG. 3. It is understood that the operations shown in method 1200 may not be exhaustive and that other operations can be performed as well before, after, or between any of the illustrated operations. Further, some of the operations may be performed simultaneously, or in a different order than that shown in FIG. 12A.

In some implementations, processing factor information describing one or more processing factors (e.g., a material property) associated with a test workpiece can be received, e.g., by a user. A processing test request may be generated in response to an instruction from the user which instructs processing device 100 to process the test workpiece. Method 1200 may begin with operation 1202 in which, in response to the processing test request, processing device 100 is controlled to process the test workpiece based on one or more candidate parameter-value sets, such that one or more preview patterns are processed onto the test workpiece under the one or more candidate parameter-value sets, respectively.

For example, in response to an input of a material property of the test workpiece from the user, a processing interface including a processing control may be displayed on terminal device 202. In response to receiving a triggering operation through the processing control from the user, a processing test request can be generated by terminal device 202. Then, the processing test request may be sent from terminal device 202 to processing device 100, causing processing device 100 to process the test workpiece based on the one or more candidate parameter-value sets. For each candidate parameter-value set, processing device 100 may be controlled to operate in a respective working state corresponding to the candidate parameter-value set based on the processing test request, such that a preview pattern corresponding to the candidate parameter-value set is processed onto the test workpiece. As a result, the test workpiece after processing may include one or more preview patterns corresponding to the one or more candidate parameter-value sets, respectively.

By presenting the processing interface including the processing control on terminal device 202, the user may be able to choose whether to trigger the processing control in the processing interface, thereby improving human-machine interaction during the material- processing process. If the user chooses to trigger the processing control, the processing test request can be generated and sent to processing device 100 in real time to ensure the timely processing of the test workpiece, such that one or more preview patterns having one or more processing effects of the one or more candidate parameter-value sets can be formed on the test workpiece after processing.

Method 1200 may proceed to operation 1204 in which a captured image of the test workpiece that is formed with the one or more preview patterns can be obtained. The captured image can be an image of the test workpiece after processing, such that the captured image may include the one or more preview patterns formed from the processing. The captured image may be captured by a capturing device such as processing device 100, terminal device 202, or any other external device with a camera. In some examples, more than one captured image can be obtained. It is contemplated that the number of captured images and the number of capturing devices that provide the captured images can be flexibly determined according to actual application scenarios, which is not limited herein.

In some implementations, after processing device 100 completes processing the test workpiece, a capture interface including a capture control may be displayed on terminal device 202. In response to receiving a triggering operation on the capture control (e.g., the user clicking on the capture control), the test workpiece can be photographed to obtain a captured image of the test workpiece. For example, terminal device 202 may receive the triggering operation on the capture control, and control a camera to take a photo of the test workpiece. The camera can be a camera of terminal device 202, a camera of processing device 100, or any other camera that is capable of taking a photo of the test workpiece, which is not limited herein. Terminal device 202 may receive the captured image from the camera and store the captured image. Terminal device 202 may also present the captured image to the user for review.

By presenting the capture interface including the capture control on terminal device 202, the user may be able to choose whether to trigger the capture control in the capture interface, thereby improving human-machine interaction during the material-processing process. If the user chooses to trigger the capture control, an image of the test piece can be captured and presented to the user in real time, thereby improving the user experience of the material-processing process.

Method 1200 may proceed to operation 1206 in which, based on a recognition processing result of the captured image, the one or more preview patterns in the captured image can be identified, and the one or more candidate parameter-value sets corresponding to the one or more preview patterns in the captured image can also be identified.

In some implementations, operation 1206 of method 1200 may further include preprocessing the captured image before a recognition process is performed on the capture image. For example, one or more preprocessing operations such as cropping, tilt correction, etc., can be performed on the captured image, and then a recognition process can be performed on the preprocessed captured image to identify the one or more preview patterns and the one or more candidate parameter-value sets corresponding to the one or more preview patterns. A cropping operation may include adjusting the boundaries or size of the captured image to remove parts that are not needed, thereby facilitating better recognition processing on the captured image. A tilt correction operation may include adjusting the captured image (which is tilted or distorted) to align it horizontally and/or vertically, thereby improving the visual effect and the image quality of the captured image to facilitate better recognition processing on the captured image. As a result, the accuracy and the efficiency of the recognition process performed on the captured image after the preprocessing can be improved.

In some implementations, operation 1206 of method 1200 may further include: (i) performing pattern-position recognition on the captured image to obtain one or more sets of position information corresponding to the one or more preview patterns, respectively; and (ii) performing parameter-value recognition on the one or more preview patterns in the captured image to obtain the one or more candidate parameter-value sets corresponding to the one or more preview patterns, respectively. For example, in step (ii), the parameter-value recognition may be performed by associating or mapping each preview pattern in the captured image with a corresponding candidate parameter set used to process the preview pattern. By performing the pattern-position recognition and the parameter-value recognition, recognition errors such as misrecognition or recognition omission can be avoided, and therefore, the accuracy of the recognition process can be enhanced. The pattern-position recognition and the parameter-value recognition are described below in more detail.

In some implementations, a set of position information corresponding to a preview pattern in the captured image can be represented by one or more coordinate positions. Each coordinate position can be determined by a set of coordinate values, e.g., (x, y), where x represents the horizontal coordinate value and y represents the vertical coordinate value. For example, a preview pattern can be outlined using a regular border (e.g., a rectangle), and the set of position information of the preview pattern in the captured image can be represented by (1) a coordinate position of the upper left corner of the regular border and (2) a coordinate position of the lower right corner of the regular border. It is contemplated that the set of position information of the preview pattern can be represented by any coordinate position(s) of the regular border, which is not limited herein.

An exemplary captured image 1250 is shown in FIG. 12B. Captured image 1250 includes nine preview patterns each having an X shape and denoted as Xᵢⱼ, where i represents the row number and j represents the column number of the respective preview pattern. For example, the nine preview patterns are arranged in a matrix form and denoted as X₁₁, X₁₂, X₁₃, X₂₁, X₂₂, X₂₃, X₃₁, X₃₂, and X₃₃, respectively (from left to right and from top to bottom). That is, the nine preview patterns are arranged in a pattern matrix MX as follows:

$$MX = [ \begin{matrix}{X}_{11} & {X}_{12} & {X}_{13} \\ {X}_{21} & {X}_{22} & {X}_{23} \\ {X}_{31} & {X}_{32} & {X}_{33}\end{matrix} ] . \qquad ( 1 )$$

The preview patterns shown in FIG. 12B are associated with two processing parameters including a laser power and a scan speed. The nine preview patterns correspond to nine candidate parameter-value sets, respectively, such that each preview pattern can be associated with a corresponding candidate parameter-value set having a corresponding laser power value and a corresponding scan speed value. For example, in the first direction (e.g., the horizontal axis) corresponding to the laser power, three laser power values 80%, 90%, and 100% are selected from left to right, and in the second direction (e.g., the vertical axis) corresponding to the scan speed, three scan speed values 5 mm/s, 10 mm/s, and 15 mm/s are selected from bottom to top. It can be understood that any one of the three laser power values combined with any one of the three scan speed values may form a candidate parameter-value set, and there are a total of nine candidate parameter-value sets, including PPG₁₁=[80%, 15 mm/s], PPG₁₂=[90%, 15 mm/s], PPG₁₃=[100%, 15 mm/s], PPG₂₁=[80%, 10 mm/s], PPG₂₂=[90%, 10 mm/s], PPG₂₃=[100%, 10 mm/s], PPG₃₁=[80%, 5 mm/s], PPG₃₂=[90%, 5 mm/s], and PPG₃₃=[100%, 5 mm/s], respectively (from left to right and top to bottom). That is, the nine candidate parameter-value sets can also be arranged in a parameter-value matrix as follows:

$$PPG = [ \begin{matrix}{PPG}_{11} & {PPG}_{12} & {PPG}_{13} \\ {PPG}_{21} & {PPG}_{22} & {PPG}_{23} \\ {PPG}_{31} & {PPG}_{32} & {PPG}_{33}\end{matrix} ] . \qquad ( 2 )$$

By performing the pattern-position recognition on captured image 1250, the nine preview patterns in captured image 1250 can be identified as the pattern matrix MX shown in the above expression (1), and nine sets of position information corresponding to the nine preview patterns are also obtained, respectively. For example, for a preview pattern which is identified as X₁₁ in the pattern matrix MX and outlined using a dashed box 1252 in FIG. 12B, a coordinate position of the upper left corner of dashed box 1252 and a coordinate position of the lower right corner of dashed box 1252 can be used as a set of position information for the preview pattern X₁₁. Also, by performing the parameter-value recognition on the nine preview patterns, nine candidate parameter-value sets corresponding to the nine preview patterns are identified as the parameter-value matrix PPG shown in the above expression (2). Each preview pattern in captured image 1250 can be associated with or mapped with a corresponding candidate parameter-value set according to a mapping relationship between the pattern matrix MX and the parameter-value matrix PPG shown above (e.g., the preview pattern X₁₁ corresponds to a candidate parameter-value set PPG₁₁, a preview pattern X₁₂ corresponds to a candidate parameter-value set PPG₁₂, so on and so forth).

Referring to FIG. 12A again, in some implementations, an identification model can be applied to perform the pattern-position recognition and the parameter-value recognition in operation 1206 of method 1200. By applying the identification model, the pattern-position recognition and the parameter-value recognition can be performed automatically. The recognition efficiency and the recognition accuracy can be improved.

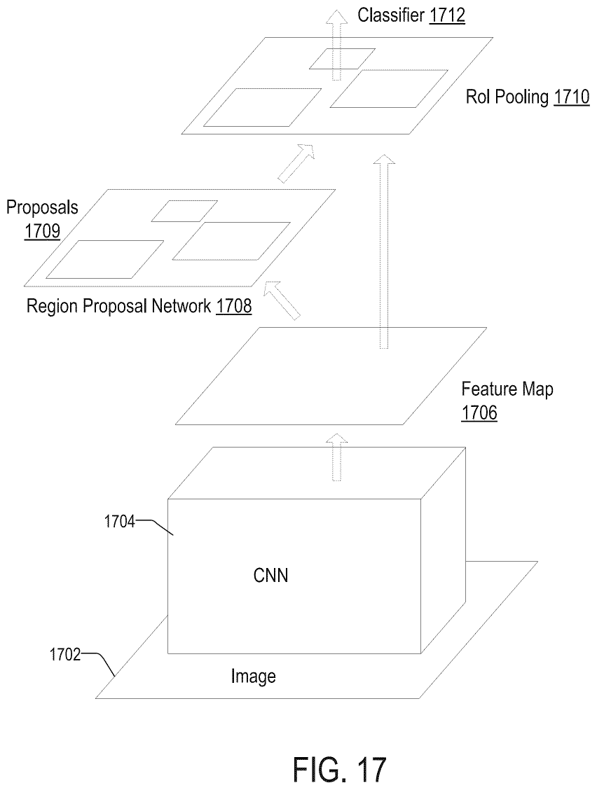

For example, the pattern-position recognition and the parameter-value recognition can be performed on terminal device 202 using an identification model. The identification model takes the captured image as an input, and provides (a) the one or more preview patterns having the one or more sets of position information and (b) the one or more candidate parameter-value sets corresponding to the one or more preview patterns as outputs. An exemplary structure of the identification model is described below in more detail with reference to FIG. 17.

In another example, the pattern-position recognition and the parameter-value recognition can be performed by a server (e.g., a local server or a web server) using the identification model. Specifically, the captured image can be sent to a server in response to an upload instruction received from a user, such that the server applies the identification model to: (i) perform the pattern-position recognition on the captured image to obtain the one or more sets of position information corresponding to the one or more preview patterns, respectively; and (ii) perform the parameter-value recognition on the one or more preview patterns in the captured image to obtain the one or more candidate parameter-value sets corresponding to the one or more preview patterns, respectively. Then, the one or more sets of position information and the one or more candidate parameter-value sets corresponding to the one or more preview patterns can be sent from the server to terminal device 202, and displayed on terminal device 202 through an interaction interface. For example, the one or more sets of position information and the one or more candidate parameter-value sets corresponding to the one or more preview patterns can be used to generate a processing parameter matrix which is displayed in the interaction interface, as described below in operation 1208.

By performing the pattern-position recognition and the parameter-value recognition on the server, computing resources on terminal device 202 can be saved (or the demand on computing resources on terminal device 202 can be lowered), when compared to performing the pattern-position recognition and the parameter-value recognition on terminal device 202. The recognition efficiency can be improved since there are more computing resources available on the server when compared to that of terminal device 202.

Referring to FIG. 12A, method 1200 may proceed to operation 1208 in which a processing preview diagram can be generated to include the one or more preview patterns corresponding to the one or more candidate parameter-value sets. For example, the processing preview diagram may include a processing parameter matrix. The one or more preview patterns with the identified one or more sets of position information, as well as the identified one or more candidate parameter-value sets, can be used to form one or more matrix elements of the processing parameter matrix. Each matrix element includes a corresponding preview pattern and is used to indicate a candidate parameter-value set of the corresponding preview pattern.

For example, referring to FIG. 12B again, a processing parameter matrix can be formed based on the pattern matrix MX and the parameter-value matrix PPG. For instance, a matrix element MEᵢⱼ of the processing parameter matrix includes a corresponding preview pattern Xᵢⱼ and is used to indicate a corresponding candidate parameter-value set PPGᵢⱼ of the preview pattern Xᵢⱼ, where i denotes a row number and j denotes a column number of the matrix element MEᵢⱼ.

Referring back to operation 1208 of method 1200 in FIG. 12A, in some implementations, the processing parameter matrix may be associated with at least a first processing parameter and a second processing parameter. Each matrix element may indicate a candidate parameter-value set including a first value for the first processing parameter and a second value for the second processing parameter. The processing parameter matrix can be generated at least by: (i) determining a first sorting position of each matrix element in a first direction based on a corresponding first value of the first processing parameter associated with the corresponding matrix element; (ii) determining a second sorting position of each matrix element in a second direction based on a corresponding second value of the second processing parameter associated with the corresponding matrix element; and (iii) arranging each matrix element in the processing parameter matrix based on the first sorting position and the second sorting position of the corresponding matrix element. In some implementations, the first sorting positions of different matrix elements can be determined in an ascending order or a descending order in the first direction, which is not limited herein. Similarly, the second sorting positions of different matrix elements can be determined in an ascending order or a descending order in the second direction, which is not limited herein.

After operation 1208 of method 1200, the processing preview diagram (e.g., the processing parameter matrix) obtained from the processing test on the test workpiece can be presented to a user through an interaction interface, and a target parameter-value set can be determined from the processing preview diagram. For example, operations like those described above with reference to operation 306 of FIG. 3, method 450 of FIG. 4B, or operations described above with reference to FIG. 11 can be performed to determine the target parameter-value set. Afterwards, processing device 100 may be controlled to process a target workpiece based on the target parameter-value set, by performing operations like those described above with reference to operation 308 of FIG. 3. The similar description will not be repeated herein.

In some implementations, historical target parameter-value sets (e.g., target parameter-value sets that have been used in the past) can be sorted according to their respective usage frequency (e.g., the number of usages) and presented to the user. Then, the user may be able to select one of the historical target parameter-value sets as a target parameter-value set to process a target workpiece.

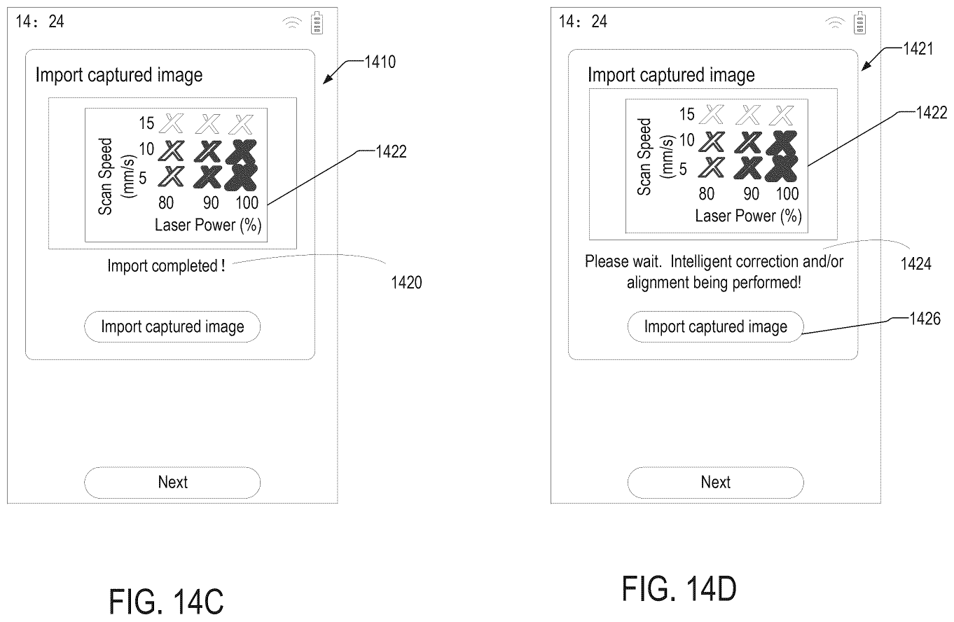

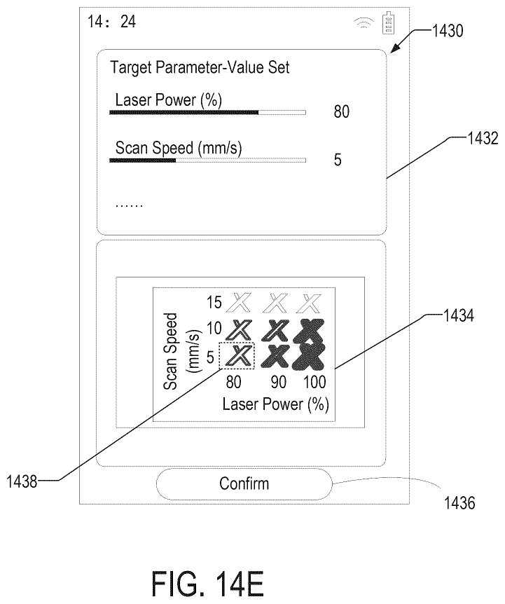

FIGS. 13A and 13B show an exemplary material-processing process performed by terminal device 202, processing device 100, and a server 1300 according to some aspects of the present disclosure. It is understood that the operations shown in the material-processing process of FIGS. 13A-13B may not be exhaustive and that other operations can be performed as well before, after, or between any of the illustrated operations. Further, some of the operations may be performed simultaneously, or in a different order than that shown in FIGS. 13A-13B. FIGS. 14A-14E shows exemplary interaction interfaces for material processing according to some aspects of the present disclosure. FIGS. 13A, 13B, and 14A-14E are described together.

At operation 1302, in response to an input of a material property of a test workpiece, a processing interface including a processing control can be displayed by terminal device 202. In response to receiving a triggering operation through the processing control, a processing test request can be generated by terminal device 202.

For example, referring to FIG. 14A, a user may place a test workpiece in processing area 11 of processing device 100, and may input material property information corresponding to the test workpiece, such as a name and a type of the material of the test workpiece, through terminal device 202. Then, in response to receiving the material property information, terminal device 202 may display a processing interface 1402 including a processing control 1401. Processing interface 1402 can also display a framing control 1403 and additional information (such as operation guidance information, attention information, etc.). In practical applications, the design of processing interface 1402 can be adjusted flexibly according to actual needs. In response to a click on processing control 1401, a processing test request can be generated.

Referring back to FIG. 13A, at operation 1303, the processing test request can be sent from terminal device 202 to processing device 100.

At operation 1304, for each candidate parameter-value set, processing device 100 may operate in a respective working state corresponding to the candidate parameter-value set based on the processing test request, such that a preview pattern corresponding to the candidate parameter-value set is processed onto the test workpiece.

At operation 1306, terminal device 202 may display a capture interface including a capture control after processing device 100 completes processing the test workpiece. After receiving a triggering operation on the capture control, the test workpiece may be photographed to obtain a captured image of the test workpiece. For example, the test workpiece may be photographed by terminal device 202, processing device 100, or any other suitable capture device, which is not limited herein.

For example, referring to FIG. 14B, a capture interface 1410 is displayed which includes a capture control “Camera” 1412. In response to a click on capture control 1412, a captured image of the test workpiece can be taken by a camera (e.g., a camera of processing device 100 or a camera of terminal device 202). Capture interface 1410 can also display image selection controls 1414, 1416 and additional information (such as corresponding operation guidance information). In practical applications, the design of capture interface 1410 can be adjusted flexibly according to actual needs. In response to a click on capture control 1412, a captured image of the test workpiece can be taken by a camera and imported to capture interface 1410. Alternatively, by selecting one of image selection controls 1414, 1416, a captured image of the test workpiece can be imported from a folder or a project. Referring to FIG. 14C, a captured image 1422 is successfully imported to capture interface 1410. Additional information “Import Completed!” 1420 is also displayed.

Referring back to FIG. 13A, at operation 1307, the captured image can be sent to a server 1300.

At operation 1308, server 1300 may apply an identification model to (i) perform pattern-position recognition on the captured image to obtain one or more sets of position information corresponding to one or more preview patterns, respectively, and (ii) perform parameter-value recognition on the one or more preview patterns in the captured image to obtain one or more candidate parameter-value sets corresponding to the one or more preview patterns, respectively.

In some implementations, when server 1300 performs the recognition processing on the captured image, terminal device 202 can display a recognition processing interface so that the user can clearly understand that the recognition processing of the captured image is currently being performed. For example, referring to FIG. 14D, a recognition processing interface 1421 is displayed to include captured image 1422 and explanation information 1424. Recognition processing interface 1421 can also display an import control 1426. In practical applications, the design of recognition processing interface 1421 can be adjusted flexibly according to actual needs.

At operation 1309 of FIG. 13A, server 1300 may send the one or more sets of position information and the one or more candidate parameter-value sets corresponding to the one or more preview patterns to terminal device 202. For example, server 1300 may encapsulate the one or more sets of position information and the one or more candidate parameter-value sets into a data exchange format such as a JSON (JavaScript Object Notation) format, and send them to terminal device 202.

At operation 1310, terminal device 202 may generate a processing preview diagram (e.g., a processing parameter matrix) based on (a) the one or more preview patterns identified by the one or more sets of position information and (b) the one or more candidate parameter-value sets corresponding to the one or more preview patterns. Terminal device 202 may display an interaction interface including the processing preview diagram and a confirmation control. After receiving a selection operation on a preview pattern from the one or more preview patterns, terminal device 202 may display a candidate parameter-value set corresponding to the selected preview pattern.

Referring to FIG. 13B, at operation 1312, after receiving a triggering operation through the confirmation control (e.g., a click on the confirmation control to confirm the parameter-value selection), terminal device 202 may determine the candidate parameter-value set corresponding to the selected preview pattern as a target parameter-value set. That is, a processing test on the test workpiece, which begins at operation 1302, ends at operation 1312, resulting in the determination of the target parameter-value set.

For example, referring to FIG. 14E, an interaction interface 1430 including a processing preview diagram 1434 is displayed. A user may issue a selection operation to select a particular preview pattern in processing preview diagram 1434, and a candidate parameter-value set corresponding to the selected preview pattern can be displayed in an upper area 1432 of interaction interface 1430. Interaction interface 1430 may also include a confirmation control 1436. Assuming that the user selects a preview pattern within a dotted box 1438 shown in FIG. 14E and presses confirmation control 1436. Then, a candidate parameter-value set corresponding to the selected preview pattern (e.g., a laser power value of 80% and a scan speed value of 5 mm/s) is determined to be a target parameter-value set.

Referring back to FIG. 13B, at operation 1314, in response to a processing request for a target workpiece, terminal device 202 may send the processing request and the target parameter-value set to processing device 100. For example, terminal device 202 may receive a command to process the target workpiece based on the target parameter-value set from the user, and generate the processing request thereof. In another example, terminal device 202 may receive a parameter applying instruction associated with the target parameter-value set from the user, and generate the processing request to include a processing execution instruction. In either example, terminal device 202 may send the processing request to instruct processing device 100 to process a target pattern onto the target workpiece based on the target parameter-value set.

At operation 1316, processing device 100 may operate in a working state corresponding to the target parameter-value set based on the processing request, such that a target pattern is processed onto the target workpiece using the target parameter-value set.

Consistent with some aspects of the present disclosure, a training process can be performed to train the identification model disclosed herein. To begin with, the training process may include: step (i)—obtaining a training sample dataset which includes at least a first sample image and at least a second sample image. The first sample image and the second sample image are respectively obtained by capturing a training workpiece formed with a plurality of sample patterns. Under certain processing factor information, the training workpiece is processed by processing device 100 according to a plurality of candidate parameter-value sets, respectively, such that the training workpiece is formed with the plurality of sample patterns. The second sample image has a label relative to the first sample image. For example, the second sample image can be labeled manually or automatically with the plurality of sample patterns and the plurality of candidate parameter-value sets, whereas the first sample image is not labeled.

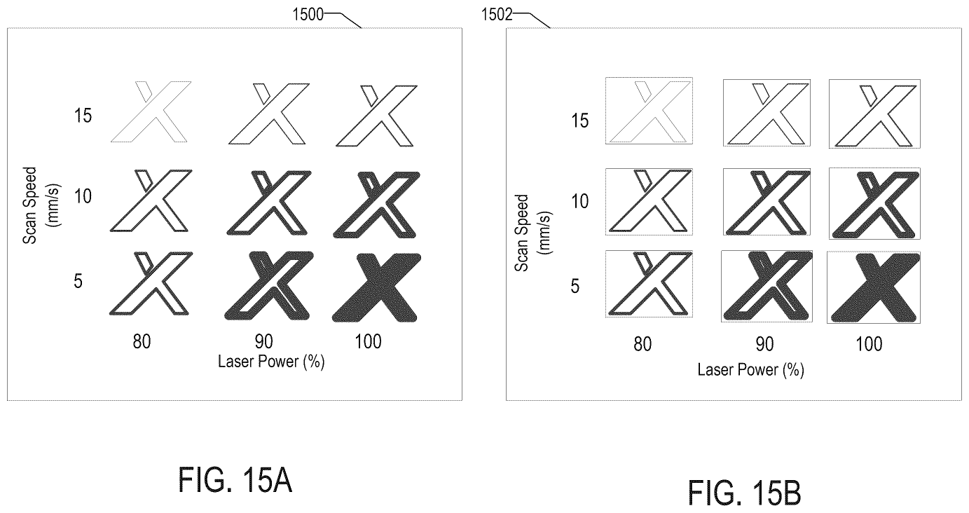

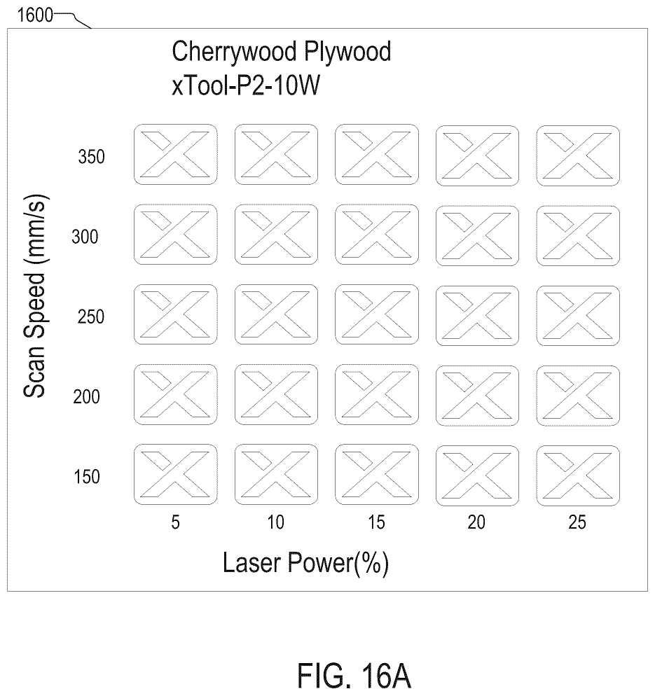

For example, FIG. 15A shows a first sample image 1500, and FIG. 15B shows a second sample image 1502 corresponding to first sample image 1500. Each of first sample image 1500 and second sample image 1502 includes nine sample patterns each having an X shape. In second sample image 1502, each of the nine sample patterns is outlined with a rectangle, such that a corresponding set of position information of the sample pattern can be determined to include a coordinate position of the upper left corner of the rectangle and a coordinate position of the bottom right corner of the rectangle. Each sample pattern in second sample image 1502 is labeled with a corresponding set of position information and a corresponding candidate parameter-value set (e.g., including a corresponding laser power value and a corresponding scan speed value).

The training process may further include: step (ii)—feeding the first sample image into a training model to obtain a recognition sample result of the first sample image; step (iii)—iteratively training the training model based on a loss value between the recognition sample result and the second sample image until the loss value is less than a preset value; and step (iv)—setting the training model that is iteratively trained to be the identification model.

In some implementations, the recognition sample result of the first sample image may include first position sample information and a first parameter-value sample set of each sample pattern in the first sample image, and is obtained as an output from the training model. For example, the first position sample information of each sample pattern may include: (1) an estimate of a coordinate position of the upper left corner of a regular border that outlines the corresponding sample pattern in the first sample image; and (2) an estimate of a coordinate position of the lower right corner of the regular border. The first parameter-value sample set of each sample pattern may include an estimate of a parameter-value set that is used to process the corresponding sample pattern onto the training workpiece.

The label of the second sample image may include second position sample information and a second parameter-value sample set of each sample pattern in the second sample image. For example, the second position sample information of each sample pattern may include: (1) a true coordinate position of the upper left corner of a regular border that outlines the corresponding sample pattern in the second sample image; and (2) a true coordinate position of the lower right corner of the regular border. The second parameter-value sample set of each sample pattern may include a true parameter-value set that is used to process the corresponding sample pattern onto the training workpiece.

To iteratively train the training model based on the loss value, step (iii) of the training process further includes: (a) determining the loss value to be one of a first difference value between the first position sample information and the second position sample information, a second difference value between the first parameter-value sample set and the second parameter-value sample set, or a sum of the first difference value and the second difference value; and (b) iteratively training the training model based on the loss value until the loss value is less than the preset value to obtain the identification model.

It is contemplated that the training workpiece, the test workpiece, and the target workpiece disclosed herein may include the same material property, similar material properties, or different material properties, depending on the actual processing scenarios. The preview patterns in the processing preview diagram, the target pattern processed onto the target workpiece, and/or the sample patterns processed onto the training workpiece may have identical pattern designs, similar pattern designs, or different pattern designs, which is not limited herein. The candidate parameter-value sets used in the training process may be the same as or different from the candidate parameter-value sets used to form a processing preview diagram (such as a processing preview diagram presented to a user for the selection of a target parameter-value set as described above).

It is contemplated that any number of training sample datasets (e.g., 1, 2, 3, etc.) can be applied to train the identification model, which is not limited herein. By using multiple training sample datasets, the training accuracy of the identification model can be improved.

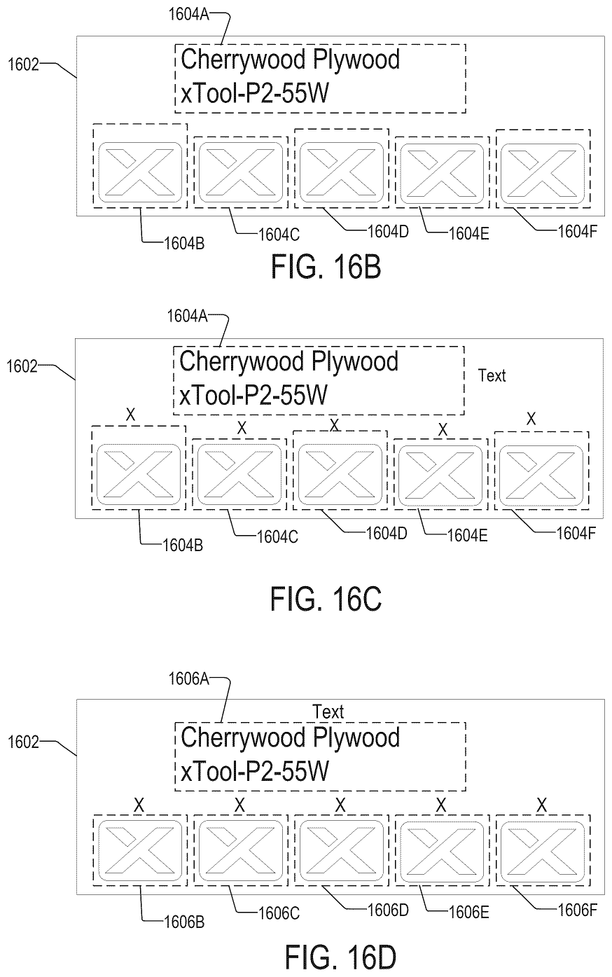

FIGS. 16A-16D show an identification process of a captured image 1600 according to some aspects of the present disclosure. As shown in FIG. 16A, captured image 1600 may include a plurality of preview patterns (5×5 preview patterns) each having an X shape, where the plurality of preview patterns are formed based on a plurality of candidate parameter-value sets, respectively. For example, each preview pattern may be formed based on a respective laser power value and a respective scan speed value. The identification process may include applying the identification model to perform a target detection on captured image 1600, including identifying or detecting preview patterns from captured image 1600 and determining candidate parameter-value sets associated with the preview patterns. The target detection may include (i) providing region proposals, (ii) identifying a classification of content in regions provided in the region proposals, and (iii) performing bounding box regression.

With respect to step (i) of the target detection, providing region proposals may refer to determining regions in an image that may include objects to be identified. For example, referring to FIG. 16A, providing the region proposals may include identifying regions in captured image 1600 that include preview patterns. With respect to a portion 1602 of captured image 1600 shown in FIG. 16B, regions in dashed bounding boxes 1604A, 1604B, 1604C, 1604D, 1604E, and 1604F can be identified through region proposals. Each of the regions in portion 1602 includes a corresponding object (e.g., a text object or a preview pattern having a predetermined shape “X”) to be identified.

With respect to step (ii) of the target detection, for each region proposal in captured image 1600, a classification recognition is performed. In some implementations, a neural network such as a convolutional neural network (CNN) can be applied in the classification recognition. For example, in portion 1602 of captured image 1600 shown in FIG. 16C, two categories are recognized, including a category of text and a category of preview patterns each having an X shape. Specifically, contents in the region proposal in dashed bounding box 1604A are categorized into the category of text, whereas contents in the region proposals in dashed bounding boxes 1604B-1604F are categorized into the category of preview patterns.

With respect to step (iii) of the target detection, bounding box regression may refer to correcting coordinates of the bounding boxes in the region proposals because these bounding boxes are usually not accurate. For example, as shown in FIGS. 16B-16C, bounding boxes 1604A-1604F are not aligned with one another. After performing the bounding box regression, bounding boxes 1604A-1604F can be corrected to be dashed bounding boxes 1606A-1606F, respectively, as shown in FIG. 16D.

Afterwards, position information of each identified preview pattern can be determined based on a corresponding corrected bounding box of the identified preview pattern. For example, the position information of each identified preview pattern may include a coordinate position of the upper left corner and a coordinate position of the lower right corner of the corresponding corrected bounding box. A corresponding candidate parameter-value set associated with each identified preview pattern can also be identified from the plurality of parameter-value sets used to form the plurality of candidate parameter-value sets.

In some implementations, the identification model used in the target detection may include a Region-Based Convolutional Neural Network (R-CNN) model, which uses selective search to extract 2000 candidate regions (e.g., 2000 region proposals) from the captured image. Then, each of the 2000 candidate regions is warped into a square and input into a corresponding CNN network included in the R-CNN model, such that the corresponding CNN network produces a feature vector as an output for the respective region. For example, the CNN network acts as a feature extractor, and outputs a dense layer including features extracted from the respective region. The features are fed into a Support Vector Machine (SVM) included in the R-CNN model to classify the presence of an object within the respective region. In addition to predicting the presence of the object within the respective region, the R-CNN model also predicts four offset values (e.g., a center coordinate position having coordinate values (x, y), a width, a height), to improve the precision of the bounding box. For example, given a region proposal having a preview pattern “X,” the R-CNN model predicts the presence of the preview pattern “X,” but the preview pattern “X” may be offset within the region proposal. Then, the offset values can help adjust the bounding box of the region proposal.

In some implementations, the identification model used in the target detection may include a fast R-CNN model. Unlike the R-CNN model which feeds 2000 region proposals into corresponding CNN networks, respectively, in the fast R-CNN model, an input image is fed into a CNN network to generate a convolutional feature map. From the convolutional feature map, region proposals are identified by applying a selective search algorithm on the convolutional feature map. Each region proposal is warped into a square, and then reshaped into a fixed size by using a Region of Interest (RoI) pooling layer so that it can be fed into a fully connected layer to generate an RoI feature vector. From the RoI feature vector, a softmax layer is used to predict the category of an object in the proposed region and the offset values of the bounding box. The fast R-CNN model is faster than the R-CNN model because in the fast R-CNN model, the CNN network does not have to be fed with 2000 region proposals each time. Instead, the convolution operation is performed only once per image and a convolutional feature map is generated from it.

In some implementations, the identification model used in the target detection may include a faster R-CNN model, which eliminates the selective search algorithm and allows the neural network to learn region proposals. A structure of the faster R-CNN model is shown in FIG. 17. Similar to the fast R-CNN model, an input image 1702 is fed into a CNN network 1704 which provides a convolutional feature map 1706 as an output. However, unlike the fast-CNN model which uses a selective search algorithm on the convolutional feature map to identify region proposals, a separate region proposal network (RPN) 1708 is used to predict region proposals 1709 from convolutional feature map 1706. The predicted region proposals 1709 are then reshaped using an RoI pooling layer 1710 which then acts as a classifier 1712 to classify the objects within the proposed regions and predict the offset values of the bounding boxes.

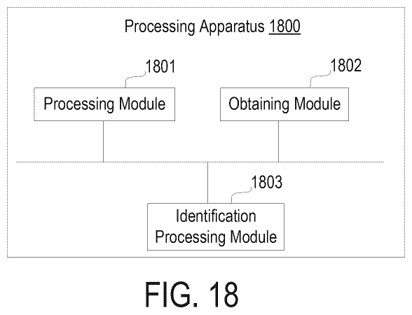

FIG. 18 shows a block diagram of a processing apparatus 1800 according to some aspects of the present disclosure. Processing apparatus 1800 may be configured on terminal device 202 or any other suitable computing device. Processing apparatus 1800 may include a processing module 1801, an obtaining module 1802, and an identification processing module 1803.

Consistent with some aspects of the present disclosure, processing module 1801 may be configured to, in response to a processing test request, control processing device 100 to process a test workpiece based on one or more candidate parameter-value sets, such that one or more preview patterns are processed onto the test workpiece under the one or more candidate parameter-value sets, respectively. For example, processing module 1801 may be configured to perform operations like those described above with reference to operation 1202 of FIG. 12A. The similar description will not be repeated herein.

Obtaining module 1802 may be configured to obtain a captured image of the test workpiece that is formed with the one or more preview patterns. For example, obtaining module 1802 may be configured to perform operations like those described above with reference to operation 1204 of FIG. 12A. The similar description will not be repeated herein.

Identification processing module 1803 may be configured to identify one or more preview patterns in the captured image and identify one or more candidate parameter-value sets corresponding to the one or more preview patterns, respectively. Identification processing module 1803 may also be configured to generate the processing preview diagram including the one or more preview patterns corresponding to the one or more candidate parameter-value sets, respectively, and determine a target parameter-value set from the processing preview diagram. For example, identification processing module 1803 may be configured to perform operations like those described above with reference to operations 1206-1208 of FIG. 12A. The similar description will not be repeated herein.

In some implementations, the identification processing module 1803 may also be configured to train the identification model by performing operations described above. The similar description will not be repeated herein.

Processing module 1801 may also be configured to control processing device 100 to process a target workpiece based on the target parameter-value set. The determination of the target parameter-value set and the controlling of processing device 100 are described above with reference to FIGS. 3, 4A-4B, and 9A-9B. The similar description will not be repeated herein.

Consistent with some aspects of the present disclosure, obtaining module 1802 may be configured to obtain processing factor information, as described above with reference to operation 302 of FIG. 3. The similar description will not be repeated herein. Identification processing module 1803 may also be configured to obtain a processing preview diagram and determine a target parameter-value set from the processing preview diagram, as described above with reference to operations 304-306 of FIG. 3. Processing module 1801 may be configured to control processing device 100 to process a target workpiece based on the target parameter-value set. The determination of the target parameter-value set and the controlling of processing device 100 are described above with reference to FIGS. 3, 4A-4B, and 9A-9B. The similar description will not be repeated herein.

In some implementations, processing apparatus 1800 may also include a display module (not shown in FIG. 18) configured to display any interaction interface disclosed herein.

In some implementations, processing apparatus 1800 may include different modules in a single device, such as an integrated circuit (IC) chip, or separate devices with dedicated functions. The IC may be implemented as an application-specific integrated circuit (ASIC) or a field-programmable gate array (FPGA). In another example, the modules of processing apparatus 1800 may be located in a cloud computing environment or a local computing environment. For example, the modules of processing apparatus 1800 may be in a single location or distributed locations but communicate with each other through a network. The modules can be hardware units (e.g., portions of an integrated circuit) designed for use with other components or software units implemented by a processor through executing at least part of a program. The program may be stored on a computer-readable medium, such as a memory, and when executed by processor, it may perform one or more functions disclosed herein.

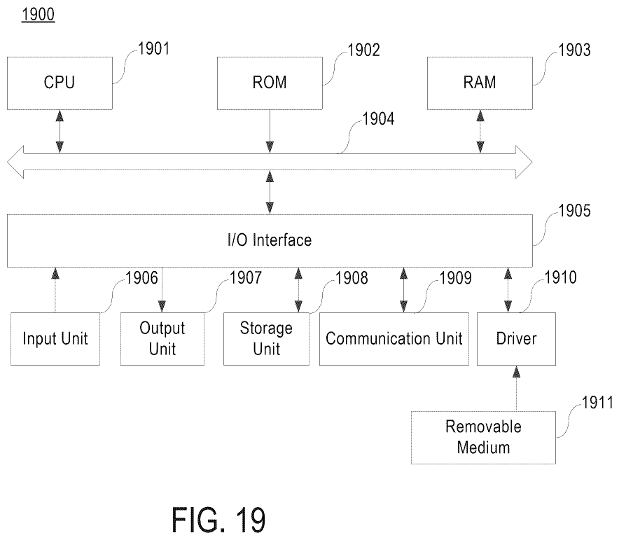

FIG. 19 shows a block diagram of a computing device 1900 according to some aspects of the present disclosure. For example, computing device 1900 can be a terminal device or a server. As shown in FIG. 19, computing device 1900 includes a Central Processing Unit (CPU) 1901, which can execute instructions according to programs stored in a Read-Only Memory (ROM) 1902 or programs loaded into a Random Access Memory (RAM) 1903 from a storage unit 1908, for example, for executing the methods disclosed herein. Various programs and data executed by CPU 1901 are also stored in RAM 1903. CPU 1901, ROM 1902, and RAM 1903 are connected to each other via a bus 1904. An Input/Output (I/O) interface 1905 is also connected to bus 1904.

The following components are connected to I/O interface 1905: an input unit 1906 including a keyboard, mouse, etc.; an output unit 1907 including a Cathode Ray Tube (CRT), Liquid Crystal Display (LCD), Light Emitting Diode (LED), Organic Light Emitting Diode (OLED), and/or a speaker, etc.; storage unit 1908 including, for example, a hard disk; and a communication unit 1909 including a network interface card such as a Local Area Network (LAN) card, modem, etc. Communication unit 1909 performs communications via networks such as the Internet. A driver 1910 is also connected to I/O interface 1905 as needed. A removable medium 1911, such as an optical disk, a magneto-optical disk, a semiconductor memory, etc., is installed on driver 1910 as needed, so that a computer program read from it can be installed into storage unit 1908 as needed.

Consistent with an aspect of the present disclosure, the processes or methods disclosed herein can be implemented as a computer software program. For example, an aspect of the present disclosure may include a computer program product, which includes a computer program carried on a computer-readable medium, the computer program containing instructions for executing the methods disclosed herein. The computer program can be downloaded and installed from the network via communication unit 1909, and/or installed from removable medium 1911. When the computer program is executed by CPU 1901, various functions disclosed herein can be implemented.

Another aspect of the present disclosure also provides a non-transitory computer-readable storage medium storing a computer program, which, when executed by a processor, implements the methods disclosed herein. The computer-readable storage medium can be included in a computing device (e.g., computing device 1900) or can exist separately without being assembled into the computing device.

The computer-readable storage medium provided by the present disclosure can be an electrical, magnetic, optical, electromagnetic, infrared, or semiconductor system or device (for example, a USB flash drive), or any combination thereof. Examples of the computer-readable storage medium include but are not limited to: portable computer disks, hard disks, RAM, ROM, erasable programmable read-only memory (EPROM or flash memory), optical fibers, portable compact disk read-only memory (CD-ROM), optical storage devices, magnetic storage devices, or any suitable combination of the above. The computer-readable storage medium can be any tangible medium containing or storing a program that can be used by or in conjunction with an instruction execution system or device. The program codes contained in the computer-readable storage medium can be transmitted by any suitable medium, including but not limited to: electrical wires, optical cables, RF (Radio Frequency), etc., or any suitable combination of the above.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A processing method, comprising:
obtaining processing factor information;
obtaining and displaying a processing preview diagram based on the processing factor information, wherein the processing preview diagram comprises one or more preview patterns corresponding to one or more candidate parameter-value sets, respectively;
in response to a selection operation performed on the processing preview diagram, determining a candidate parameter-value set corresponding to the selection operation to be a target parameter-value set; and
controlling a processing device to process a target workpiece based on the target parameter-value set.

2. The processing method of claim 1, wherein obtaining and displaying the processing preview diagram based on the processing factor information comprises:
obtaining a processing parameter matrix based on the processing factor information, wherein the processing parameter matrix comprises one or more matrix elements that are formed by the one or more preview patterns and indicate the one or more candidate parameter-value sets, respectively; and
displaying the processing parameter matrix in an interaction interface.

3. The processing method of claim 2, wherein in response to the selection operation performed on the processing preview diagram, determining the candidate parameter-value set corresponding to the selection operation to be the target parameter-value set comprises:
receiving, from the selection operation, an input to select a first matrix element of the processing parameter matrix through the interaction interface; and
in response to the input to select the first matrix element, determining the candidate parameter-value set corresponding to the first matrix element to be the target parameter-value set.

4. The processing method of claim 2, wherein:
the one or more candidate parameter-value sets comprise one or more first values of a first processing parameter and one or more second values of a second processing parameter, respectively; and
the processing method further comprises generating the processing parameter matrix at least by:
determining a first sorting position of each matrix element in a first direction based on a corresponding first value of the first processing parameter associated with the corresponding matrix element;
determining a second sorting position of each matrix element in a second direction based on a corresponding second value of the second processing parameter associated with the corresponding matrix element; and
arranging each matrix element in the processing parameter matrix based on the first sorting position and the second sorting position of the corresponding matrix element.

5. The processing method of claim 4, wherein in the processing parameter matrix, a matrix element having a larger first value of the first processing parameter has a larger first sorting position in the first direction, and a matrix element having a larger second value of the second processing parameter has a larger second sorting position in the second direction.

6. The processing method of claim 2, wherein:
each matrix element comprises a corresponding preview pattern that reflects a processing effect produced by a candidate parameter-value set indicated by the matrix element; and
the processing parameter matrix further comprises the processing factor information, and the processing factor information comprises at least one of a material property, a device type of the processing device, or a processing type of the processing device.

7. The processing method of claim 2, wherein the processing parameter matrix is in an image format, and the processing method further comprises:
in response to a hovering operation performed on the processing parameter matrix, obtaining a relative position of the hovering operation with respect to the processing parameter matrix;
based on the relative position of the hovering operation, determining that the hovering operation points to a second matrix element in the processing parameter matrix, and determining a position of the second matrix element; and
displaying a hovering identification image at the position of the second matrix element,
wherein the hovering identification image comprises at least one of an identification effect diagram matching a pattern size of the second matrix element or a corresponding candidate parameter-value set indicated by the second matrix element.

8. The processing method of claim 2, wherein displaying the processing parameter matrix in the interaction interface comprises:
displaying a processing parameter configuration panel in the interaction interface, wherein the processing parameter configuration panel comprises the processing parameter matrix; and
in response to a click operation on the processing parameter matrix, enlarging the processing parameter matrix and displaying the enlarged processing parameter matrix in the interaction interface.

9. The processing method of claim 2, wherein the interaction interface further displays a configuration panel that comprises a parameter adjustment control, and the processing method further comprises:
in response to an adjustment operation to adjust a value of a processing parameter in the target parameter-value set through the parameter adjustment control, updating the target parameter-value set based on the adjusted value of the processing parameter;
generating an updated processing preview diagram based on the updated target parameter-value set and the processing factor information; and
displaying the updated processing preview diagram in the interaction interface.

10. The processing method of claim 2, further comprising:
selecting at least one processing parameter and at least one candidate value range of the at least one processing parameter;
given one or more processing factors, performing a processing test based on the at least one processing parameter and the at least one candidate value range to obtain a test result corresponding to the one or more processing factors, wherein the one or more processing factors comprise at least a material property of the target workpiece to be processed;
adjusting the at least one candidate value range based on the test result to obtain at least one target value range of the at least one processing parameter corresponding to the one or more processing factors; and
by using the at least one processing parameter as at least one dimension of the processing parameter matrix, selecting one or more values from the at least one target value range to generate one or more matrix elements of the processing parameter matrix, respectively, wherein the one or more candidate parameter-value sets corresponding to the one or more matrix elements comprise the one or more values of the at least one processing parameter, respectively.

11. The processing method of claim 10, wherein by using the at least one processing parameter as the at least one dimension of the processing parameter matrix, selecting the one or more values from the at least one target value range to generate the one or more matrix elements of the processing parameter matrix comprises:
generating the one or more preview patterns based on the one or more candidate parameter-value sets; and
using the one or more preview patterns and the one or more candidate parameter-value sets to form the one or more matrix elements,
wherein the processing method further comprises storing the processing parameter matrix and a mapping relationship between the one or more processing factors and the processing parameter matrix.

12. The processing method of claim 2, wherein:
the processing factor information describes at least one of a material property, a device type, or a processing type; and
obtaining the processing parameter matrix based on the processing factor information comprises:
obtaining a mapping table that describes a mapping relationship between processing factors and processing parameter matrices; and
querying the mapping table to obtain the processing parameter matrix that matches the at least one of the material property, the device type, or the processing type.

13. The processing method of claim 1, wherein obtaining and displaying the processing preview diagram based on the processing factor information comprises:
displaying an interaction interface that comprises a configuration panel, wherein the configuration panel comprises a parameter adjustment control for adjusting a value of at least one processing parameter;
in response to an adjustment operation to adjust the value of the at least one processing parameter through the parameter adjustment control, displaying the adjusted value of the at least one processing parameter in the interaction interface;
generating the processing preview diagram based on the adjusted value of the at least one processing parameter and the processing factor information; and
displaying the processing preview diagram in the interaction interface.

14. The processing method of claim 13, wherein in response to the selection operation performed on the processing preview diagram, determining the candidate parameter-value set corresponding to the selection operation to be the target parameter-value set comprises:
when no further adjustment operation is received through the parameter adjustment control within a preset time duration, determining a latest processing preview diagram corresponding to a latest adjustment operation; and
in response to a selection operation performed on the latest processing preview diagram, determining the target parameter-value set comprising an adjusted value of the at least one processing parameter that is adjusted by the latest adjustment operation.

15. The processing method of claim 1, wherein the processing factor information comprises at least a material property of a test workpiece, and obtaining and displaying the processing preview diagram based on the processing factor information comprises:
in response to a processing test request, controlling the processing device to process the test workpiece based on the one or more candidate parameter-value sets, such that the one or more preview patterns are processed onto the test workpiece under the one or more candidate parameter-value sets, respectively;
obtaining a captured image of the test workpiece that is formed with the one or more preview patterns;
based on a recognition processing result of the captured image, identifying the one or more preview patterns in the captured image and identifying the one or more candidate parameter-value sets corresponding to the one or more preview patterns in the captured image, respectively; and
generating and displaying the processing preview diagram corresponding to the material property of the test workpiece, wherein the processing preview diagram comprises the one or more preview patterns corresponding to the one or more candidate parameter-value sets, respectively.

16. The processing method of claim 15, wherein identifying the one or more preview patterns in the captured image and identifying the one or more candidate parameter-value sets corresponding to the one or more preview patterns in the captured image, respectively, comprises:
performing pattern-position recognition on the captured image to obtain one or more sets of position information corresponding to the one or more preview patterns, respectively; and
performing parameter-value recognition on the one or more preview patterns in the captured image to obtain the one or more candidate parameter-value sets corresponding to the one or more preview patterns, respectively.

17. The processing method of claim 16, wherein an identification model is applied to perform the pattern-position recognition and the parameter-value recognition, and
wherein identifying the one or more preview patterns in the captured image and identifying the one or more candidate parameter-value sets corresponding to the one or more preview patterns in the captured image, respectively, further comprises:
sending the captured image to a server, to cause the server to apply the identification model to:
perform the pattern-position recognition on the captured image to obtain the one or more sets of position information corresponding to the one or more preview patterns, respectively; and
perform the parameter-value recognition on the one or more preview patterns in the captured image to obtain the one or more candidate parameter-value sets corresponding to the one or more preview patterns, respectively; and
receiving, from the server, the one or more sets of position information and the one or more candidate parameter-value sets corresponding to the one or more preview patterns.

18. The processing method of claim 15, wherein in response to the processing test request, controlling the processing device to process the test workpiece based on the one or more candidate parameter-value sets comprises:
in response to an input of a material property of the test workpiece, displaying a processing interface comprising a processing control;
in response to receiving a triggering operation through the processing control, generating the processing test request; and
sending the processing test request to the processing device to cause the processing device to process the plurality of sample patterns onto the test workpiece.

19. The processing method of claim 1, further comprising:
displaying a parameter sharing interface which comprises the target parameter-value set;
in response to a sharing selection operation performed on the parameter sharing interface, using the target parameter-value set selected by the sharing selection operation as a shared parameter-value set, and using an entity selected by the sharing selection operation as a shared entity; and
sending the shared parameter-value set to the shared entity.

20. The processing method of claim 1, wherein the processing device comprises:
a slide rail;
a processing platform comprising a processing area for placing the target workpiece; and
a processing head movably provided on the slide rail,
wherein the processing head is controlled to move on the slide rail in the processing area to perform a manufacturing processing on the target workpiece based on the target parameter-value set, and
wherein the manufacturing processing comprises at least one of a laser processing, a cutting processing, or a printing processing.

21. The processing method of claim 20, wherein the processing device further comprises:
a housing; and
a cover plate,
wherein the housing and the cover plate are configured to enclose an inner space for accommodating the target workpiece to be processed,
wherein the housing has an opening that communicates with the inner space, and the cover plate is connected to the housing to expose or cover the opening,
wherein the cover plate comprises a light-transmitting window, and
wherein the slide rail, the processing head, and the processing platform are located in the inner space, and a camera device is provided in the inner space.

22. A processing system, comprising:
a processing device, comprising:
a base plate comprising a processing area for placing a target workpiece to be processed; and
a processing head configured to move in the processing area;
a terminal device communicatively coupled to the processing device and comprising a processor configured to:
receive processing factor information;
obtain and display a processing preview diagram based on the processing factor information, wherein the processing preview diagram comprises one or more preview patterns corresponding to one or more candidate parameter-value sets, respectively;
in response to a selection operation performed on a first preview pattern from the one or more preview patterns, determine a first candidate parameter-value set corresponding to the first preview pattern to be a target parameter-value set; and
control the processing device to process the target workpiece based on the target parameter-value set.

23. A non-transitory computer-readable storage medium having instructions stored thereon, wherein the instructions, when executed by at least one processor, cause the at least one processor to perform a processing method comprising:
receiving processing factor information;
obtaining and displaying a processing preview diagram based on the processing factor information, wherein the processing preview diagram comprises one or more preview patterns corresponding to one or more candidate parameter-value sets, respectively;
in response to a selection operation performed on a first preview pattern from the one or more preview patterns, determining a first candidate parameter-value set corresponding to the first preview pattern to be a target parameter-value set; and
controlling a processing device to process a target workpiece based on the target parameter-value set.
